(19) United States
(12) Patent Application Publication
(10) Pub. No.: US 2010/0185317 A1
(43) Pub. Date: Jul. 22, 2010

(54) VARIABLE MEDIUM PROCESSING APPARATUS AND VARIABLE MEDIUM PROCESSING METHOD

(75) Inventors: Makoto ASO, Himeji-shi (JP); Tomoyuki Kubo, Himeji-shi (JP); Hirofumi Ozaki, Himeji-shi (JP); Yoshifumi Kawabata, Himeji-shi (JP); Kenichi Hattori, Himeji-shi (JP)

Correspondence Address: FOLEY AND LARDNER LLP;SUITE 500, 3000 K STREET NW, WASHINGTON, DC, 20007, US

(73) Assignee: GLORY LTD.

(21) Appl. No.: 12/357,806

(22) Filed: Jan. 22, 2009

(51) Int. Cl. G06F 7/00

(52) U.S. Cl. 700/214

(57) ABSTRACT

A valuable-medium processing apparatus includes a receptacle in which valuable mediums are put; an escrow unit that temporarily holds the valuable mediums; a storage unit that stores therein the valuable mediums; a transporting unit including a holding route in which the valuable mediums put in the receptacle are temporarily held in the escrow unit and then transported to the storage unit, and a non-holding route in which the valuable mediums put in the receptacle are transported to the storage unit without being held in the escrow unit; and a control unit that, when a predetermined condition is satisfied, controls the transporting unit to determine a transporting route by selecting one of the holding route and the non-holding route, and transport the valuable mediums via the determined route.

### BACKGROUND OF THE INVENTION

1. Field of the Invention

The present invention relates to a valuable-medium processing apparatus and a valuable-medium processing method. More particularly, the present invention relates to a valuable-medium processing apparatus that includes an escrow unit that temporarily holds a valuable medium put in the apparatus and to a valuable-medium processing method performed by the valuable-medium processing apparatus.

2. Description of the Related Art

Valuable-medium processing apparatuses configured to identify and count deposited valuable mediums such as banknotes and coins and then store the valuable mediums in a storage unit are widely known. An example of this type of valuable-medium processing apparatus is the depositing and dispensing apparatus that includes an escrow unit, which is disclosed in Japanese Patent Application Laid-open No. 2004-145600. After banknotes put in a deposit receptacle are identified, the escrow unit temporarily holds the banknotes before they are stored in a storage unit.

During the deposit process in this type of valuable-medium processing apparatus that includes the escrow unit, after valuable mediums are put in a receptacle, the put-in valuable mediums are transported to an identifying unit and are each identified and counted. Thereafter, the valuable mediums are transported to an escrow unit and temporarily held therein before being stored in the storage unit.

With the valuable-medium processing apparatus, thereafter, a counting result is displayed on a predetermined display unit and a user confirms the amount to be deposited. When the user performs a predetermined operation to accept the deposit, the valuable mediums temporarily held in the escrow unit are transported to the storage unit and stored therein.

When the user performs a predetermined operation to reject the deposit, the valuable-medium processing apparatus returns the valuable mediums held in the escrow unit to the user.

As described above, in the valuable-medium processing apparatus that includes a escrow unit, when the user performs the operation to accept the deposit, the valuable mediums are then stored in the storage unit. When the user performs the operation to reject the deposit, the valuable mediums temporarily stored in the escrow unit are directly returned to the user. Therefore, when receiving returned valuable mediums, the user can receive the valuable mediums put in by the user, which reduces suspicion during transactions and leads to strict transactions.

In a valuable-medium processing apparatus without a escrow unit, after valuable mediums put in the apparatus are identified and counted, they are directly stored in a storage unit. Therefore, when returning the valuable medium to the user, it is required to pay out the valuable mediums from the storage unit one by one. In contrast, in the valuable-medium processing apparatus that includes a escrow unit, when returning valuable mediums, it is not required to pay out the valuable mediums from the storage unit one by one to return them to the user. Therefore, compared with the valuable-medium processing apparatus without a escrow unit, the valuable mediums can be generally returned promptly.

However, with the valuable-medium processing apparatus that includes the escrow unit, when the user performs the operation not to reject the deposit but to accept the deposit, more time is required from when valuable mediums are put in until they are stored in the storage unit compared with the time required with a valuable-medium processing unit without a escrow unit. This is because extra time is required from when the valuable mediums are put in the apparatus until they are stored in the storage unit.

### SUMMARY OF THE INVENTION

It is an object of the present invention to at least partially solve the problems in the conventional technology.

To solve the above problems and to achieve the above object, the present invention is a valuable-medium processing apparatus including a receptacle in which valuable mediums are put; an escrow unit that temporarily holds the valuable mediums; a storage unit that stores therein the valuable mediums; a transporting unit that includes a holding route in which the valuable mediums put in the receptacle are temporarily held in the escrow unit and then transported to the storage unit, and a non-holding route in which the valuable mediums put in the receptacle are transported to the storage unit without being held in the escrow unit; and a control unit that, when a predetermined condition is satisfied, controls the transporting unit to determine a transporting route by selecting one of the holding route and the non-holding route, and transport the valuable mediums via the determined route.

The present invention further includes a valuable-medium information acquiring unit that acquires information about the valuable mediums put in the receptacle, wherein, when the control unit determines that the predetermined condition is satisfied based on the valuable-medium information acquired by the valuable-medium information acquiring unit, the control unit controls the transporting unit so that the valuable mediums are transported via the non-holding route.

In the present invention, the valuable-medium information acquiring unit acquires, as the valuable-medium information, information about a quantity of the valuable mediums put in the receptacle, and the control unit determines that the predetermined condition is satisfied, when the quantity of the valuable mediums put in the receptacle is equal to or larger than a predetermined threshold value, based on the information about the quantity of the valuable mediums which is acquired by the valuable-medium information acquiring unit.

In the present invention, the valuable-medium information acquiring unit includes a type information acquiring unit that acquires, as the valuable-medium information, type information representing a type of each of the valuable mediums put in the receptacle, and the control unit determines that the predetermined condition is satisfied when the type information acquired by the type information acquiring unit represents a single type.

In the present invention, the valuable-medium information acquiring unit acquires shapes or sizes of the valuable mediums as the valuable-medium information, and the control unit determines that the predetermined condition is satisfied when the acquired information representing the shapes or sizes of the valuable mediums does not contain information representing a valuable medium of a specific shape or specific size.

The present invention further includes a storage-limit detecting unit that detects a number of valuable mediums that can be stored in the storage unit, wherein the control unit determines that the predetermined condition is satisfied when the number of valuable mediums that can be stored, which is detected by the storage-limit detecting unit, is equal to or larger than a predetermined number.

The present invention further includes a user identifying unit that identifies a user who puts the valuable mediums in the receptacle, wherein the control unit determines that the predetermined condition is satisfied when the user who is identified by the user identifying unit is a specific user.

The present invention further includes a quantity input unit that inputs a quantity of valuable mediums to be put in the receptacle; a discrepancy calculating unit that calculates a discrepancy between the quantity input by the quantity input unit and the quantity of the valuable mediums which is acquired by the valuable-medium information acquiring unit; a discrepancy record memory unit that stores therein the discrepancy detected by the discrepancy calculating unit in association with a user who puts in the valuable mediums about which the discrepancy is caused; and a reliability-level determining unit that determines a level of reliability of the user identified by the user identifying unit based on the information stored in the discrepancy record memory unit, wherein the control unit determines that the predetermined condition is satisfied, when the level of reliability of the user which is determined by the reliability-level determining unit is equal to or higher than a predetermined level of reliability.

The present invention further includes an input unit that inputs information about any one of types, a total quantity, a total value of the valuable mediums put in the receptacle; a discrepancy calculating unit that calculates a discrepancy between the information input by the input unit and the information about the valuable mediums, which is acquired by the valuable-medium information acquiring unit; a discrepancy record memory unit that stores therein the discrepancy detected by the discrepancy calculating unit in association with a user who puts in the valuable mediums about which the discrepancy is caused; and a reliability-level determining unit that determines a level of reliability of the user identified by the user identifying unit, wherein the control unit determines that the predetermined condition is satisfied, when the level of reliability of the user which is determined by the reliability determining unit is equal to or higher than a predetermined level of reliability.

The present invention further includes a time table in which timing for selecting and determining a route for transporting the valuable mediums is set, wherein the control unit determines that the predetermined condition is satisfied during a predetermined time set in the time table.

The present invention further includes a front-back information acquiring unit that acquires, as the valuable-medium information, front-back information representing front or back of the valuable mediums put in the receptacle, wherein the control unit controls the transporting unit to determine the transporting route by selecting one of the holding route and the non-holding route, and transport the valuable mediums via the determined route, based on the front-back information acquired by the front-back information acquiring unit.

The present invention further includes a storage state detecting unit that detects whether there is a valuable medium in the storage unit, wherein the control unit determines that the predetermined condition is satisfied when the storage state detecting unit detects that there is no valuable medium in the storage unit.

In the present invention, the storage unit includes a plurality of storage units provided corresponding respectively to the types of valuable mediums, wherein the control unit determines that the predetermined condition is satisfied, when the storage state detecting unit detects that there is no valuable medium in the storage units, when the valuable-medium information acquiring unit acquires information representing type(s) of the valuable mediums put in the receptacle, and when the type of the valuable mediums corresponding to the storage unit in which the storage state detecting unit detects that there is no valuable medium is same as the type of the valuable mediums, which is acquired by the valuable-medium information acquiring unit.

The present invention further includes a valuable-medium information acquiring unit that acquires information about the valuable mediums put in the receptacle, wherein the control unit determines whether the predetermined condition is satisfied, based on the valuable-medium information acquired by the valuable-medium information acquiring unit, and, when the control unit determines that the predetermined condition is satisfied based on the valuable-medium information acquired by the valuable-medium information acquiring unit, the control unit controls the transporting unit to transport the valuable mediums via the holding route.

According to the present invention, there is provided a valuable-medium processing method that is performed by a valuable-medium processing apparatus, and that includes acquiring valuable-medium information about valuable mediums put in a receptacle; determining whether a predetermined condition is satisfied based on the acquired valuable-medium information; and controlling a transporting unit that transports the valuable mediums put in the receptacle to the storage unit to determine a transporting route by selecting one of a holding route in which the valuable mediums put in the receptacle are temporarily held in the escrow unit and then stored in the storage unit, and a non-holding route in which the valuable mediums put in the receptacle are transported to the storage unit without being held in the escrow unit, and transport the valuable mediums via the determined route, when the predetermined condition is satisfied.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of an appearance of a depositing and dispensing machine according to an embodiment;

FIG. 2 is a cross sectional explanatory diagram of the inside of a processor according to the embodiment;

FIG. 3 is a functional block diagram of a configuration of the depositing and dispensing machine according to the embodiment;

FIG. 4 is an explanatory diagram of an example of a discrepancy record table according to the embodiment;

FIG. 5 is an explanatory diagram of an example of a user information table according to the embodiment;

FIG. 6 is an explanatory diagram of an example of a time table according to the embodiment;

FIG. 7 is an explanatory diagram of an example of an operation record table according to the embodiment;

FIG. 8 is a flowchart of processes performed by a control unit of the depositing and dispensing machine according to the embodiment;

FIG. 9 is a flowchart of processes performed by the control unit of the depositing and dispensing machine according to the embodiment;

FIG. 10 is a flowchart of processes performed by the control unit of the depositing and dispensing machine according to the embodiment;

FIG. 11 is an explanatory diagram of a modification of the depositing and dispensing machine according to the embodiment; and

FIG. 12 is an explanatory diagram of a modification of the depositing and dispensing machine according to the embodiment.

### DETAILED DESCRIPTION OF THE PREFERRED EMBODIMENTS

Preferred embodiments of a valuable-medium processing apparatus according to the present invention are explained in detail below with reference to the accompanying drawings. In an embodiment, the case where the present invention is applied to a depositing and dispensing machine that performs a process of depositing money or a process of dispensing money is explained as an example. Alternatively, the present invention may be applied to other valuable-medium processing apparatuses configured to receive not only money but also arbitrary valuable mediums such as gift certificates or vouchers and perform identifying process and counting process.

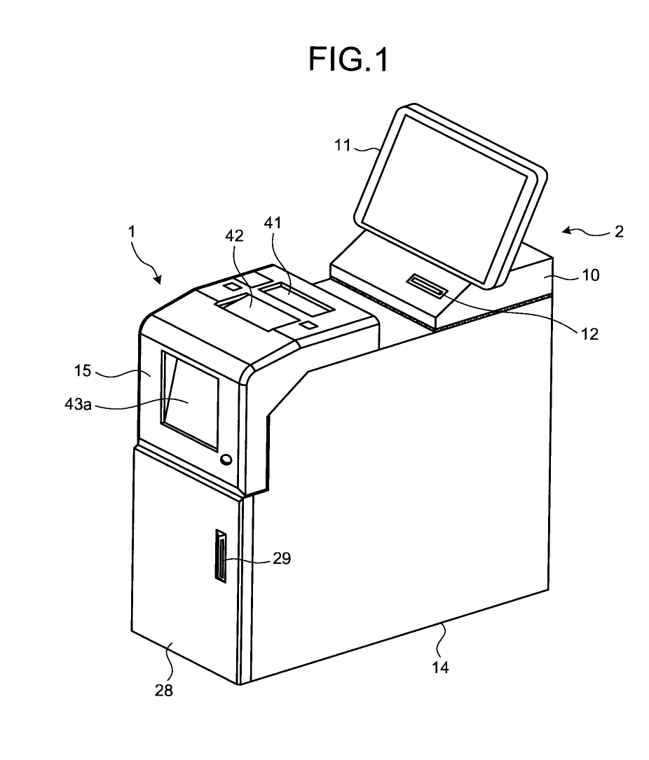

FIG. 1 is a perspective view of an appearance of a depositing and dispensing machine according to an embodiment. The depositing and dispensing machine shown in FIG. 1 is set in a lobby, a counter, or a cashier room of a baking facility, or a cashier room of a shop such as a department store or a supermarket. Depending on operations performed by a customer, a worker, or a cashier manager (hereinafter, “user”) of the shop, the depositing and dispensing machine performs the process for depositing money or the process for dispensing money.

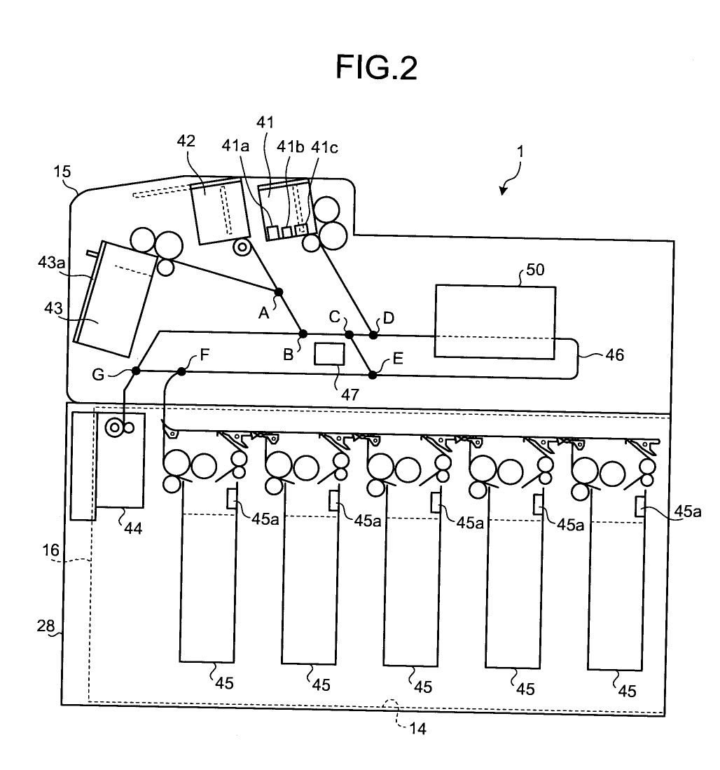

As shown in FIG. 1, the depositing and dispensing apparatus includes a processor 1 that performs a plurality of types of processes on money, such as a deposit process in which money put in from the outside is taken to the inside and the money is identified and counted and then stored in a sorted-money storage unit 45 (see FIG. 2), and a dispensing process in which money stored in the inside is paid out to the outside; and a terminal 2 that controls operations of the processor 1.

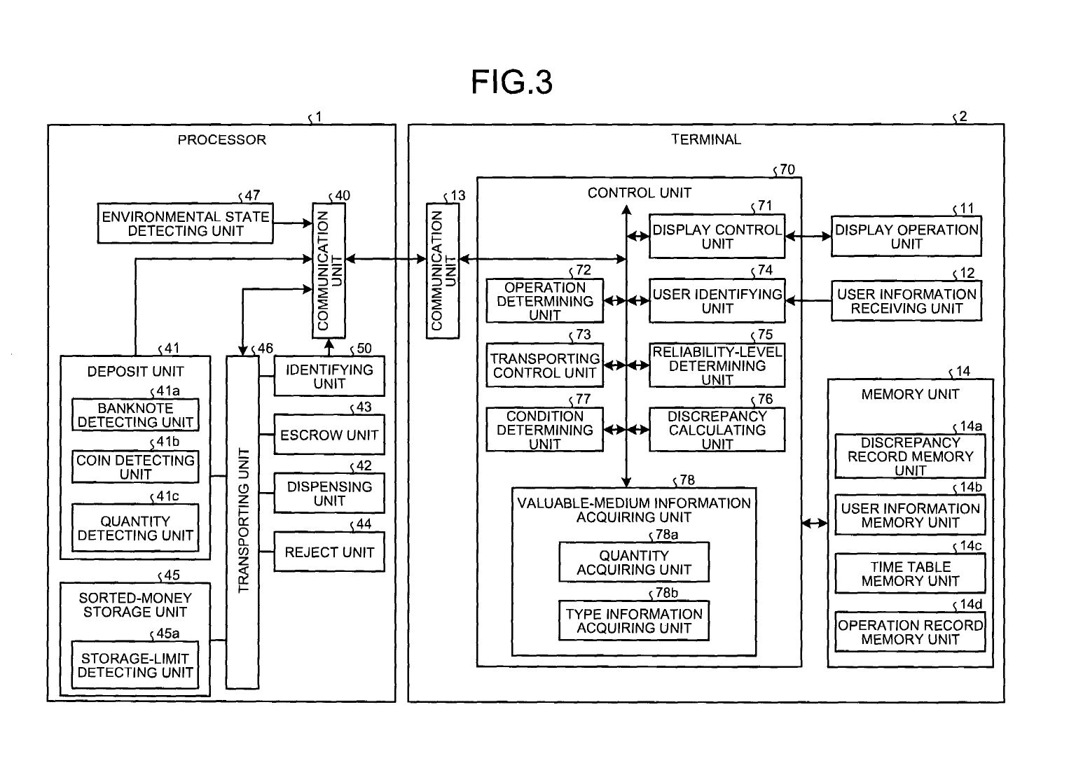

The terminal 2 includes a body 10 in which a control unit 70 that is to be explained below (see FIG. 3) and that generally controls operations of the depositing and dispensing machine is housed; and a display operation unit 11 that displays, to a user, guidance information corresponding to contents of various types of processes relating to money, such as contents of various types of processes performed by the processor 1 and an operation procedure for performing each process, and that has a touch panel function in which the user touches a predetermined position on the guidance information being displayed, so that the processor 1 is caused to perform various types of processes such as the deposit process or the dispensing process. A configuration may be adopted in which, instead of the display operation unit 11 having the touch panel operation, a display unit without the touch panel function and an operation unit such as a keyboard operated by the user are provided.

On the front surface of the body 10 of the terminal 2, is provided a user information receiving unit 12 into which an ID card is inserted when the user uses the depositing and dispensing machine. In the ID card, identification information for causing the depositing and dispensing machine to identify each user (hereinafter, “user identification information”) is recorded.

The processor 1 includes an upper unit 15 provided to an upper part of a housing 14; and a lower unit 16 (see FIG. 2) that is provided inside the housing 14 and to be explained below.

The upper unit 15 includes a deposit unit 41 provided on an upper surface of the boxy housing 14 including a receptacle in which money is put when the user performs a deposit operation; a dispensing unit 42 having a dispensing receptacle from which money is paid out when the user performs a dispensing operation; and a shutter 43a that is provided on a front surface, and that opens or closes a escrow unit 43 (see FIG. 2) that temporarily holds the money put in the deposit unit 41.

In FIG. 1, a reference numeral 28 denotes a door provided on the front surface of the housing 14, and a reference numeral 29 denotes a door open/close lever for locking or unlocking a door. The lower unit 16 is configured to be pulled to the outside after the door is opened.

Internal structures of the upper unit 15 and the lower unit 16 are explained below with reference to FIG. 2. FIG. 2 is a cross sectional explanatory diagram of the inside of the processor 1.

As shown in FIG. 2, the processor 1 includes the upper unit 15 and the lower unit 16. The upper unit 15 includes the deposit unit 41, the dispensing unit 42, the escrow unit 43, a transporting unit 46, an identifying unit 50, and an environmental state detecting unit 47. The lower unit 16 includes a reject unit 44 and the sorted-money storage units 45. Although illustration is omitted from FIG. 2, the processor 1 includes a communication unit 40 (see FIG. 3) that communicates various types of information with the terminal 2.

The deposit unit 41 includes a box having an opening on the upper surface of the upper unit 15; and a shutter that opens or closes the upper opening of the box. The shutter is usually in a closed state, and enters an open state when the user performs an operation for deposit (hereinafter, “deposit operation”) such that money can be put in the box.

The deposit unit 41 includes a banknote detecting unit 41a that detects that a banknote is put in the box; and a coin detecting unit 41b that detects that a coin is put in the box; and a quantity detecting unit 41c that detects the number/quantity of money put in the box. Each of the banknote detecting unit 41a, the coin detecting unit 41b, and the quantity detecting unit 41c sends a detection result to the terminal 2. The money put in the deposit unit 41 is transported by the transporting unit 46 to the inside of the processor 1.

In the embodiment, the configuration is adopted in which banknotes and coins are received by only the deposit unit 41. Alternatively, a configuration may be adopted in which the deposit unit 41 for banknotes and the deposit unit 41 for coins are provided independently. When this configuration is adopted, the deposit unit 41 for banknotes is provided with the banknote detecting unit 41a and the quantity detecting unit 41c, and the deposit unit 41 for coins is provided with the coin detecting unit 41b and the quantity detecting unit 41c.

The dispensing unit 42 is provided to an anterior part of the processor 1 compared with that of the deposit unit 41, and includes a box having an opening on the front surface of the upper unit 15, and the shutter 43a that opens or closes the upper opening of the box. The shutter 43a is usually in the closed state. When the user performs an operation for returning money, the shutter 43a enters the open state such that the user can take out the money from the box.

The escrow unit 43 is provided on the side of the front surface of the upper unit 15, and includes a box having an opening on the front-surface side of the upper unit 15 and the shutter 43a that opens or closes the upper opening of the box. The shutter 43a is usually in the closed state, and enters the open state when the user performs an operation for returning money such that the user can take out the money put thereto by the user.

Before the money to be deposited, which is put in the deposit unit 41, is stored in the sorted-money storage unit 45, the escrow unit 43 temporarily holds the money. In addition, the escrow unit 43 temporarily holds money to be dispensed that is transported from the sorted-money storage unit 45, before it is transported to the dispensing unit 42.

The identifying unit 50 identifies pieces of the money transported from the transporting unit 46 one by one by determining whether a piece of money is genuine, whether a piece of money is fit, a country to which the piece of money belongs, a money type, a size, a shape, and a thickness of the piece of money, and sends identifying results to the terminal 2. The reject unit 44 includes a box that stores therein, for example, money about which the identifying unit 50 determines that it cannot be handled.

The sorted-money storage unit 45 includes a box called stacker in which a money put in the deposit unit 41 or money to be dispensed are stored. The box is provided for each type of money. In the embodiment, the sorted-money storage unit 45 is provided for each money type. However, the storage unit that stores therein money is not limited to this. The storage unit may be a type-mixed storage unit that stores therein various types of money.

Each of the sorted-money storage units 45 includes a storage-limit detecting unit 45a that detects the number of pieces of money that can be currently stored in the stacker, and detects whether there is money in the stacker. The storage-limit detecting unit 45a sends a detection result to the terminal 2 each time the number of pieces of money changes.

The transporting unit 46 includes a belt transporter including a pair of belts that transport pieces of money while sandwiching the money. The transporting unit 46 transports money between the deposit unit 41, the dispensing unit 42, the escrow unit 43, the reject unit 44, the sorted-money storage unit 45, and the identifying unit 50.

The transporting unit 46 has branch points A, B, C, D, E, F, and G on a money transporting route, and is configured to switch the money transporting route according to transporting control by the terminal 2.

Specifically, the transporting unit 46 is configured to determine the money transporting route by selecting it from a holding route, in which money put in the deposit unit 41 is held in the escrow unit 43 and then transported to the sorted-money storage unit 45, and a non-holding route, in which money put in the deposit unit 41 is not held in the escrow unit 43 and transported to the sorted-money storage unit 45, when the control unit 70 of the terminal 2 to be explained below determines that a predetermined condition is satisfied based on various types of conditions such as an operation state of the depositing and dispensing machine and operational environments, and configured to transport the money via the determined transporting route.

When transporting money via the holding route in the deposit process, the transporting unit 46 transports the money to the deposit unit 41, the branch point D, the identifying unit 50, the branch points E, C, B, and A, and the escrow unit 43 in order, and the money is temporarily held in the escrow unit 43.

Thereafter, when the user performs an operation for accepting the deposit, the transporting unit 46 transports the money via the escrow unit 43, the branch points A, B, C, D, E, and F, and the sorted-money storage unit 45 in order, and the money is stored in the sorted-money storage unit 45.

In contrast, when transporting money via the non-holding route in the deposit process, the transporting unit 46 transports the money via the deposit unit 41, the branch point D, the identifying unit 50, the branch points E and F, and the sorted-money storage unit 45 in order.

In the embodiment, the configuration is adopted in which the transporting unit 46 automatically switches between the holding route and the non-holding route based on control of the terminal 2. Alternatively, a configuration can be adopted in which money is transported while the transporting unit 46 automatically switches between the holding route and the non-holding route based on the control of the terminal 2 in the dispensing process.

In the above configuration, when transporting money via the holding route in order, the transporting unit 46 transports the money via the sorted-money storage unit 45, the branch points E and E, the identifying unit 50, the branch points D, C, B, and A, and the escrow unit 43, and the money is temporarily held in the escrow unit 43.

Thereafter, after all money to be dispensed is stored in the escrow unit 43, the transporting unit 46 transports the money via the escrow unit 43, the branch point A, and the dispending unit 42 in order, and the money is dispensed.

In contrast, when transporting money via the non-holding route, the transporting unit 46 transports the money via the sorted-money storage unit 45, the branch points F and E, the identifying unit 50, the branch points D, C, B, and A, and the dispensing unit 42 in order, and the money is dispensed.

The environmental state detecting unit 47 is provided inside the upper unit 15. Specifically, the environmental state detecting unit 47 detects a temperature and humidity near the transporting unit 46, and sends a detection result at predetermined timing to the terminal 2.

Configurations and functions of the processor 1 and the terminal 2 are explained more in detail below with reference to FIG. 3. FIG. 3 is a functional block diagram of a configuration of the depositing and dispensing machine. As shown in FIG. 3, the depositing and dispensing machine according to the embodiment includes the processor 1 and the terminal 2.

As described above, the processor 1 includes the deposit unit 41, the dispensing unit 42, the escrow unit 43, the reject unit 44, the sorted-money storage unit 45, the transporting unit 46, the environmental state detecting unit 47, the identifying unit 50, and the communication unit 40.

The deposit unit 41 includes a hopper that pays out pieces of money, which are put in by the user in the deposit process, one by one to the transporting unit 46, and has a function of taking in the put-in money to the inside of the depositing and dispensing machine.

The deposit unit 41 includes the banknote detecting unit 41a, the coin detecting unit 41b, and the quantity detecting unit 41c. When the banknote detecting unit 41a detects that a banknote is put in the deposit unit 41, it sends a signal representing the fact to the terminal 2 via the communication unit 40. Similarly, when the coin detecting unit 41b detects that a coin is put in the deposit unit 41, it sends a signal representing the fact to the terminal 2 via the communication unit 40.

When the number of banknotes and coins put in the deposit unit 41 exceeds a predetermined number, the quantity detecting unit 41c sends a signal representing the fact to the terminal 2 via the communication unit 40.

When the volume of banknotes and coins exceeds a predetermined volume, the quantity detecting unit 41c sends a signal representing the fact to the terminal 2 via the communication unit 40. In this case, when the height of banknotes and coins put in the deposit unit 41 and stacked inside the deposit unit 41 exceeds a predetermined height, or when the weight of banknotes and coins put in the deposit unit 41 exceeds a predetermined weight, the quantity detecting unit 41c determines that the volume of the banknotes or coins exceeds the predetermined volume, and sends a signal representing the fact to the terminal 2 via the communication unit 40.

The dispensing unit 42 has a function of receiving money to be dispensed, which is transported from the sorted-money storage unit 45 in the dispensing process, and the escrow unit 43 has a function of temporarily holding money transported from the deposit unit 41 or money transported from the sorted-money storage unit 45.

The identifying unit 50 has a function of identifying pieces of money, which are transported by the transporting unit 46, one by one by determining whether a piece of money is genuine, whether the piece of money is fit, a country to which the piece of money belongs, a money type, a size, a shape, and a thickness of the piece of money, and sends identifying results to the terminal 2 via the communication unit 40. The reject unit 44 has a function of storing therein money that is identified by the identifying unit 50 as a counterfeit note, an unfit note, or money that cannot be dealt with by the processor 1.

The sorted-money storage unit 45 has a function of storing money, which are put in the deposit unit 41, or money to be dispensed. The sorted-money storage unit 45 includes the storage-limit detecting unit 45a. Each time the number of pieces of money in the stacker changes, the storage-limit detecting unit 45a sends a detection result to the terminal 2 via the communication unit 40.

The environmental state detecting unit 47 has a function of sending, when the humidity or the temperature near the transporting unit 46 is out of a predetermined range, a signal representing the fact to the terminal 2 via the communication unit 40.

The communication unit 40 is an interface that communicates various types of signals with a communication unit 13 of the terminal 2.

The terminal 2 includes the communication unit 13, the control unit 70, the display operation unit 11, the user information receiving unit 12, and a memory unit 14.

The display operation unit 11 is a touch panel display device, and it has a function of displaying, to the user, guidance information corresponding to contents of various types of processes relating to money, such as various types of contents of processes performed by the processor 1 and an operation procedure for performing each process, and a function of causing the processor 1 to perform various types of processes such as the deposit process or the dispensing process when the user touches a predetermined position on the guidance information being displayed.

The display operation unit 11 displays various types of information based on display control by the control unit 70, and outputs a signal corresponding to an operation by the user to the control unit 70.

The user information receiving unit 12 includes a card reader, and it has a function of receiving an ID card in which user identification information is recorded, reading the user identification information from the received ID card, and outputting the user identification information to the control unit 70.

The communication unit 13 is an interface that communicates various types of signals with the communication unit 40 of the processor 1.

The memory unit 14 includes a rewritable non-volatile memory that stores therein various types of information, such as various types of record information about the deposit process or the dispensing process performed by the depositing and dispensing machine and image information to be displayed on the display operation unit 11.

Specifically, in the embodiment, the inside of the memory unit 14 is divided into a plurality of storage areas of a discrepancy record memory unit 14a, a user information memory unit 14b, a time table memory unit 14c, and an operation record memory unit 14d.

The discrepancy record memory unit 14a, the user information memory unit 14b, the time table memory unit 14c, and the operation record memory unit 14d store therein various types of tables to be referred by the control unit 70 when determining whether to switch the money transporting route from the holding route to the non-holding route or from the non-holding route to the holding route.

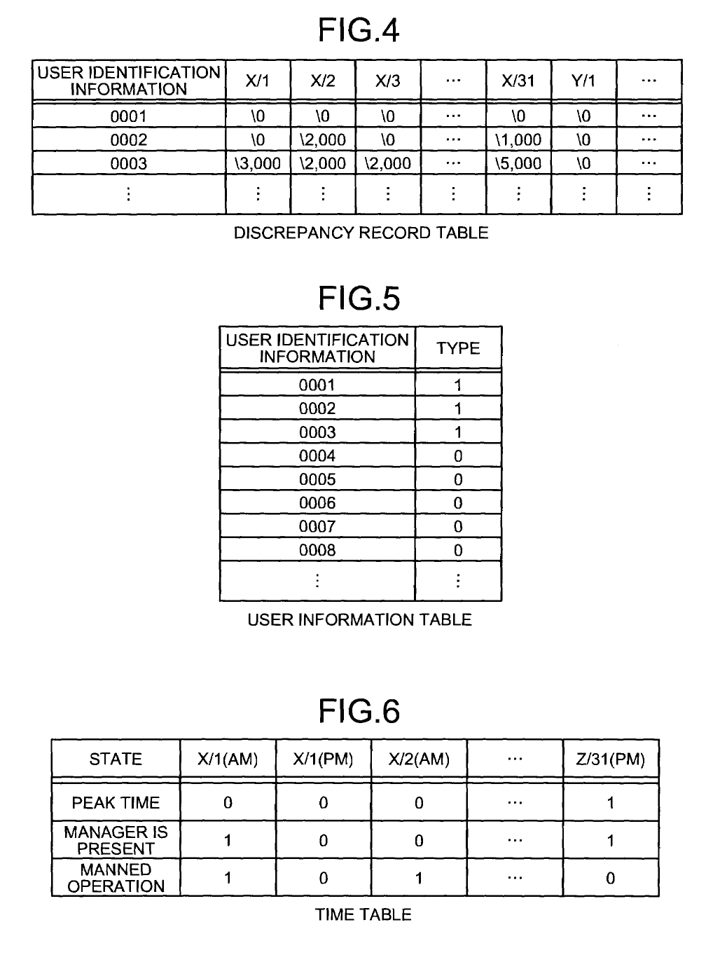

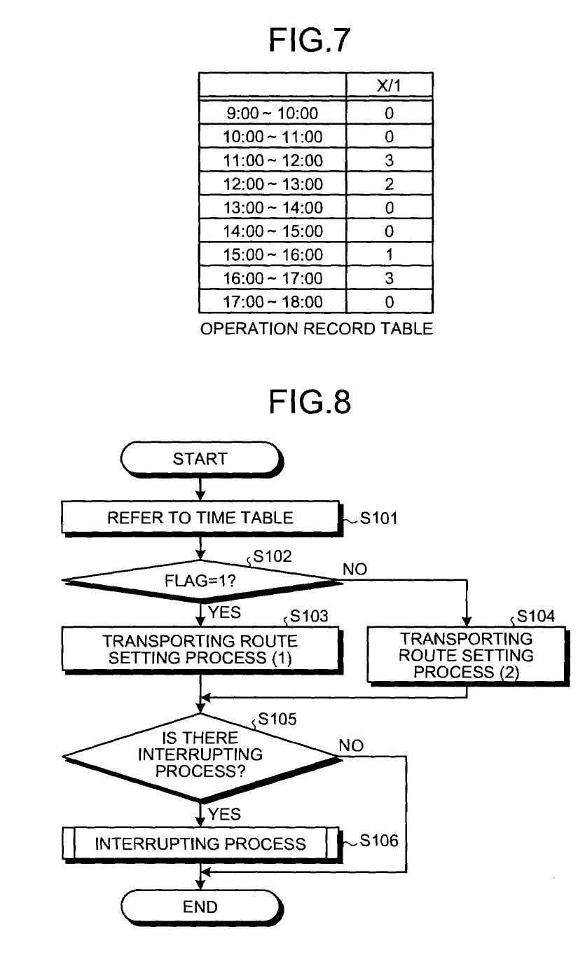

The various types of tables stored in the memory unit 14 are explained below with reference to FIGS. 4 to 7. FIG. 4 is an explanatory diagram of an example of the discrepancy record table. FIG. 5 is an explanatory diagram of an example of the user information table. FIG. 6 is an explanatory diagram of an example of the time table. FIG. 7 is an explanatory diagram of an example of the operation record table.

The discrepancy record memory unit 14a stores therein the discrepancy record table shown in FIG. 4. As shown in FIG. 4, the discrepancy record table stores therein user identification information about each user, dates on which a user corresponding to the user identification information performs the deposit process, amounts of money to be deposited input by the user in the deposit process on the dates, and a discrepancy between the amounts and results of counting money obtained by the control unit 70 in association with each other.

In other words, record information of each user about a discrepancy between an input amount of money and a counted amount of money during the deposit process is recorded in the discrepancy record table. As an example of the discrepancy record information, FIG. 4 shows discrepancy record information about the deposit process performed on 1st of a month X or thereafter by users of user information 0001 to 0003.

In the user information memory unit 14b, the user information table shown in FIG. 5 is stored. As shown in FIG. 5, in the user information table, user identification information about a large number of users who use the depositing and dispensing machine is recorded in association with types of users. The type “1” denotes a specific user such as a manager of a shop in which the depositing and dispensing machine is set, or a manager of the depositing and dispensing machine. The type “0” denotes a general user in the shop.

In other words, in the user information table, information on whether each user is the specific user or a general user is recorded. FIG. 5 shows, as an example, a user information table in the case where users corresponding to the user identification information 0001 to 0003 are specific users, and users corresponding to the user identification information 0004 or larger number are general users.

In the time table memory unit 14c, the time table shown in FIG. 6 is stored. As shown in FIG. 6, in the time table, each business day of the shop where the depositing and dispensing machine is set is divided into AM and PM. To each business day and each period, “0” and “1” are stored as information on whether the period is a peak time, whether the manager is present in the period, and whether manned operation is performed in the period.

In the embodiment, “1” and “0” are recorded in the time table respectively as information representing a peak time and information representing an off-peak time. “1” and “0” are recorded in the time table respectively as information representing that the manager is present and information representing that the manager is absent. “1” and “0” are recorded in the time table respectively as information representing the manned operation and information representing the unmanned operation. The manned operation is an operation in which a dedicated manager of the depositing and dispensing machine deposits money brought by a user in the depositing and dispensing machine on behalf of the user. The unmanned operation is an operation in which money brought by each user is deposited by the user in the depositing and dispensing machine.

A configuration may be adopted in which the time table is set by manually inputting it by a specific manager at the beginning of a month or the beginning of a year. Alternatively, a configuration may be adopted in which the time table is remotely set from, for example, a predetermined server connected to the terminal 2 via a communication network.

In the operation record memory unit 14d, the operation record table shown in FIG. 7 is stored. As shown in FIG. 7, in the operation record table, a record of the number of times for which transporting of money is stopped due to a trouble in a predetermined time is recorded.

The control unit 70 has a function of generally controls operations of the depositing and dispensing machine, and it includes an information processing apparatus including a CPU (Central Processing Unit), a ROM (Read Only Memory), and a RAM (Random Access Memory).

The control unit 70 includes a display control unit 71, an operation determining unit 72, a transporting control unit 73, a user identifying unit 74, a reliability-level determining unit 75, a discrepancy calculating unit 76, a condition determining unit 77, and a valuable-medium information acquiring unit 78 that are started by reading predetermined programs and executes the programs, using the RAM as work areas.

The display control unit 71, the operation determining unit 72, the transporting control unit 73, the user identifying unit 74, the reliability-level determining unit 75, the discrepancy calculating unit 76, the condition determining unit 77, and the valuable-medium information acquiring unit 78 are connected to the communication unit 13 via a communication bus.

The display control unit 71 is a processing unit that reads, from the memory unit 14, various types of image information corresponding to the operation state of the depositing and dispensing machine, and that causes the display operation unit 11 to display the image information.

The operation determining unit 72 detects and determines the operation on the display operation unit 11 by the user, and sends a control signal corresponding to the operation to the transporting control unit 73. When the transporting control unit 73 receives the control signal, it sends an instruction corresponding to the received control signal to the transporting unit 46 of the processor 1 via the communication unit 13 and the communication unit 40 of the processor 1 to cause the transporting unit 46 to operate and cause the processor 1 to perform various types of processing such as the deposit process or the dispensing process.

Specifically, in the embodiment, when the operation determining unit 72 detects that the user has performed the deposit operation after inputting and specifying the amount of money to be deposited, the operation determining unit 72 outputs a signal representing the fact to the condition determining unit 77.

Upon receiving the signal, the condition determining unit 77 determines that the predetermined condition is satisfied, and selects and sets the non-holding route as the money transporting route. After such setting, the transporting control unit 73 transmits, when driving the transporting unit 46, a command for transporting the money via the non-holding route to the transporting unit 46 via the communication unit 13 of the terminal 2 and the communication unit 40 of the processor 1. The condition determining unit 77 may be configured to select and set the holding route as the money transporting route when the user performs the deposit operation without specifying the amount of money to be deposited.

Thus, to a user who previously knows the amount of money to be deposited and is less likely to perform a return operation after a counting result is obtained, because the deposit process is completed in a way that the money put in the processor 1 is stored in the sorted-money storage unit 45 without being temporarily stored in the escrow unit 43, the deposit process speeds up compared with the case where the money is temporarily stored in the escrow unit 43, which increases the convenience.

In the embodiment, when the deposit operation is performed after the amount of money to be deposited is specified, the non-holding route is selected as the money transporting route. Alternatively, the non-holding route may be selected and set as the money transporting route, when the deposit operation is performed without specifying the amount of money to be deposited. With such setting, to a user who performs the deposit process without specifying the amount of money to be deposited, giving priority to speeding up the process rather than strictness during transactions, the deposit process speeds up compared with the case where the money is temporarily stored in the escrow unit 43, which increases the convenience.

When the operation determining unit 72 detects that the user does not perform the normal deposit process but performs the deposit operation for the purpose of refilling the sorted-money storage units 45 with money, the operation determining unit 72 then outputs a signal notifying the fact to the condition determining unit 77.

Upon receiving the signal, the condition determining unit 77 determines that the predetermined condition is satisfied, and selects and sets the non-holding route as the money transporting route. With such setting, the transporting control unit 73 sends, when driving the transporting unit 46, a command for transporting the money via the non-holding route to the transporting unit 46 via the communication unit 13 of the terminal 2 and the communication unit 40 of the processor 1. The condition determining unit 77 may be configured to select and set the holding route as the money transporting route when the user performs the deposit operation for the purpose of the normal deposit process.

Thus, to a user who deposits money for refilling, which is already counted and whose amount is determined, because the deposit process is completed in a way that the money for refilling, which is put in the processor 1, is stored in the sorted-money storage unit 45 without being temporarily held in the escrow unit 43, the deposit process speeds up compared with the case where the money is temporarily held in the escrow unit 43, which increases the convenience.

The transporting control unit 73 is a processing unit that controls operations of the transporting unit 46 to causes the processor 1 to perform the various types of processes such as the deposit process and the dispensing process, by sending a command corresponding to an operation by the user, which is determined by the operation determining unit 72, to the transporting unit 46 of the processor 1 via the communication unit 13 of the terminal 2 and the communication unit 40 of the processor 1.

When driving the transporting unit 46, the transporting control unit 73 sends a command for transporting the money via the non-holding route according to the setting, which is done when the condition determining unit 77 determines that the predetermined condition is satisfied, to the transporting unit 46 via the communication unit 13 of the terminal 2 and the communication unit 40 of the processor 1.

Based on the user identification information read from the ID card of the user by the user information receiving unit 12, the user identifying unit 74 determines whether the user is the specific user such as the manager of the shop or the manager of the depositing and dispensing machine. When the user is the specific user, the user identifying unit 74 sends a signal representing the fact to the condition determining unit 77.

Upon receiving the signal, the condition determining unit 77 determines that the predetermined condition is satisfied, and selects and sets the non-holding route as the money transporting route. With such setting, the transporting control unit 73 sends, when driving the transporting unit 46, a command for transporting the money via the non-holding route to the transporting unit 46 via the communication unit 13 of the terminal 2 and the communication unit 40 of the processor 1. The condition determining unit 77 may be configured to select and set the holding route as the money transporting route when the user identifying unit 74 determines that the user is a general user.

Thus, to a user who is in charge of a result of transactions, such as the manager of the shop or the manager of the depositing of the dispensing machine, because the deposit process is completed in a way that the money put in the processor 1 is stored in the sorted-money storage unit 45 without being temporarily held in the escrow unit 43, the deposit process speeds up compared with the case where the money is temporarily stored in the escrow unit 43, which increases the convenience.

Referring to the discrepancy record table (see FIG. 4) stored in the discrepancy record memory unit 14a of the memory unit 14, and based on the user identification information read from the ID card of the user by the user information receiving unit 12, the reliability-level determining unit 75 determines the level of reliability of the user from the discrepancy caused in the deposit process performed before by the user, and sends a determination result to the condition determining unit 77.

The reliability-level determining unit 75 determines the level of reliability such that the user with a small total amount of money of discrepancies has a high level of reliability. The total amount of money of discrepancies is a sum of absolute values of positive values of discrepancies and negative values of discrepancies.

The reference for determining the level of reliability is not limited to this. Alternatively, for example, the level of reliability may be determined such that a user with a small number of times for which discrepancies are caused has a high level of reliability. Alternatively, the level of reliability may be determined based on, for example, a discrepancy rate. In this case, reliability is determined in a way that a discrepancy rate is calculated based on an equation: discrepancy rate =discrepancy in amount of money/sales proceeds or collected amount of money. A user with a low discrepancy rate has a high level of reliability.

Upon receiving a result of determining a level of reliability, the condition determining unit 77 determines whether the received level of reliability is higher than a predetermined level of reliability. When the condition determining unit 77 determines that the received level of reliability is higher than the predetermined level of reliability, the condition determining unit 77 determines that the predetermined condition is satisfied, and selects and sets the non-holding route as the money transporting route.

With such setting, the transporting control unit 73 sends, when driving the transporting unit 46, a command for transporting the money via the non-holding route to the transporting unit 46 via the communication unit 13 of the terminal 2 and the communication unit 40 of the processor 1. The condition determining unit 77 may be configured to select and set the holding route as the money transporting route when the level of reliability of the user received from the reliability-level determining unit 75 is lower than the predetermined level of reliability.

Thus, to a user who has a higher level of reliability regarding strictness during transactions, because the deposit process is completed in a way that the money put in the processor 1 is stored in the sorted-money storage unit 45 without being temporarily held in the escrow unit 43, the deposit process speeds up compared with the case where the money is temporarily stored in the escrow unit 43, which increases the convenience.

The discrepancy calculating unit 76 is a processing unit that calculates a discrepancy caused in the deposit process based on the amount of money to be deposited, which is input via the display operation unit 11, and the quantity of money, i.e., result of counting the money, which is acquired by a quantity acquiring unit 78a to be described below from the terminal 2. The discrepancy calculating unit 76 performs a process for recording the calculated discrepancy in the discrepancy record table (see FIG. 4) stored in the discrepancy record memory unit 14a of the memory unit 14.

In the embodiment, when specifying the amount of money to be deposited, the user specifies the amount of money to be deposited via manual input by operating the display operation unit 11. Alternatively, for example, the terminal 2 may be configured to communicate with other electric devices via a predetermined communication network. In this case, the amount of money to be deposited is specified in a way that information about the amount of money to be deposited is sent to the terminal 2 from other devices via the network. Alternatively, the terminal 2 may be provided with an information reading device such as an IC card reader. In this case, the amount of money to be deposited is specified by causing the information reading device to read the amount of money to be deposited from a predetermined electric medium in which the amount of money to be deposited is recorded.

The valuable-medium information acquiring unit 78 is a processing unit that performs a process for receiving a result of detecting money, which is sent from the quantity detecting unit 41c of the processor 1, and a result of identifying the money, which is sent from the identifying unit 50, and that acquires a plurality of types of valuable-medium information about the money put in the deposit unit 41. The valuable-medium information acquiring unit 78 includes the quantity acquiring unit 78a and a type information acquiring unit 78b.

Specifically, the valuable-medium information acquiring unit 78 acquires, as valuable-medium information, for example, information representing the amount of money put in the deposit unit 41, information about a country to which a piece of money belongs, information representing whether the piece of money is fit and whether the piece of money is genuine, information representing a money type, information representing a shape and a size of the piece of money, information representing a note type of the piece of money, information representing the front or back of the piece of money, and information representing a money transporting direction.

The quantity acquiring unit 78a is a processing unit that acquires the number of valuable mediums put in the deposit unit 41 as the valuable-medium information. Upon receiving a signal transmitted to the terminal 2 by the quantity detecting unit 41c, which is provided in the deposit unit 41, when the number of banknotes or coins put in the deposit unit 41 is equal to or larger than the pre-set predetermined number (threshold value), the quantity acquiring unit 78a sends the signal to the condition determining unit 77.

The quantity acquiring unit 78a may be configured such that, upon receiving a signal sent by the quantity detecting unit 41c to the terminal 2 when the height of pieces of money stacked in the deposit unit 41 exceeds the predetermined height, or when the weight of pieces of money put in the deposit unit 41 exceeds the predetermined weight, the quantity acquiring unit 78a sends the signal to the condition determining unit 77.

When the condition determining unit 77 receives the signal, it determines that the predetermined condition is satisfied, and selects and sets the non-holding route as the money transporting route. With such setting, the transporting control unit 73 sends, when driving the transporting unit 46, a command for transporting the money via the non-holding route to the transporting unit 46 via the communication unit 13 of the terminal 2 and the communication unit 40 of the processor 1. The condition determining unit 77 may be configured to select and set the holding route as the money transporting route when it does not receive the predetermined signal from the quantity acquiring unit 78a.

As described above, in the depositing and dispensing machine according to the embodiment, in the case where it is expected that a relatively long time is required for the deposit process as in the case where a large quantity of money is put in the processor 1, the put-in money is identified and counted and then stored in the sorted-money storage unit 45 without being temporarily held in the escrow unit 43. Therefore, the deposit process speeds up, which increases the convenience to a user who deposits a large quantity of money.

The quantity acquiring unit 78a also performs a process for counting the quantity of money put in the deposit unit 41 based on the number of times for which the identifying unit 50 performs the identifying process on each piece of money, and also performs a process for storing the counting result in a predetermined area of the memory unit 14.

The type information acquiring unit 78b is a processing unit that acquires type information representing the types of pieces of money put in the deposit unit 41. From a result of the process for identifying the pieces of money by the identifying unit 50, the type information acquiring unit 78b acquires, as the type information, for example, information about a country to which a piece of money belongs (for example, information representing which of yen, dollar, euro each piece of money is), the information representing whether the piece of money is fit or whether the piece of money is genuine (for example, information representing how much each piece of money is damaged), the information representing a money type (for example, information representing the amount of each piece of money), the information about a shape of the piece of money (for example, a circumferential shape and a thickness of each banknote or each coin in a plan view), and the information representing a note type of the piece of money (for example, information representing that each piece of money is a new banknote (new coin) or an old banknote (old coin)).

The type information acquiring unit 78b determines whether the pieces of money put in the deposit unit 41 are money of a single country (pieces of money issued by the same country), and sends a result of the determination to the condition determining unit 77.

When the determination result received from the type information acquiring unit 78b represents that the pieces of money are of the single country, the condition determining unit 77 determines that the predetermined condition is satisfied, and selects and sets the non-holding route as the money transporting route. The condition determining unit 77 can be configured to, when the determination result received from the type information acquiring unit 78b represents that the pieces of money of a plurality of countries are mixed, select and set the holding route as the money transporting route.

As described above, in the depositing and dispensing machine according to the embodiment, when performing the process for depositing pieces of money of a single country, which is easier compared with the case of processing pieces of money of a plurality of countries, is processed, the money put in the machine is identified and counted and then stored in the sorted-money storage unit 45 without being temporarily held in the escrow unit 43. This speeds up the deposit process, which increases the convenience to a user who deposits pieces of money of a single country. In contrast, when processing pieces of money of a plurality of countries, the process is more complex than when processing pieces of money of a single country, and there is a possibility that frequency in which an error occurs increases. In this case, transporting the money via the holding route makes it easier to separate cash about which it is determined that it is to be processed from cash money about which it is not determined that it is to be processed.

The type information acquiring unit 78b determines whether the money put in the deposit unit 41 is of a single money type (for example, all pieces of money are ten-thousand yen notes), and sends a result of the determination to the condition determining unit 77.

When the determination result received from the type information acquiring unit 78b represents that the pieces of money are of a single money type, the condition determining unit 77 determines that the predetermined condition is satisfied, and sets the non-holding route as the money transporting route. In contrast, when the determination result received from the type information acquiring unit 78b represents that the pieces of money are of a plurality of money types (for example, the state where ten-thousand yen notes, five-thousand yen notes, and one-thousand yen notes are mixed), the condition determining unit 77 selects and sets the holding route as the money transporting route.

As describe above, in the depositing and dispensing machined according to the embodiment, when performing the process, which is not likely to cause suspicion during transactions, the money put in the machine is identified and counted and then stored in the sorted-money storage unit 45 without being temporarily held in the escrow unit 43. This speeds up the deposit process, and increases the convenience to a user who deposits pieces of money of a single money type.

The type information acquiring unit 78b determines whether a piece of money in a specific shape (for example, a polygonal coin) is included in the money put in the deposit unit 41 based on the acquired type information, and sends a result of the determination to the condition determining unit 77.

When the determination result received from the type information acquiring unit 78b represents that no piece of money in a specific shape or a specific shape is included, the condition determining unit 77 determines that the predetermined condition is satisfied, and selects and sets the non-holding route as the money transporting route. The condition determining unit 77 may be configured to, when the determination result received from the type information acquiring unit 78b represents that no piece of money in the specific shape or the specific size is included, select and set the holding route as the money transporting route.

As described above, in the depositing and dispensing machine according to the embodiment, when no piece of money in a specific shape, which is difficult to transport or store compared with that in a normal shape or a normal size, is included in the money put in the machine, the put-in money is identified and counted and then stored in the sorted-money storage unit 45 without being temporarily held in the escrow unit 43. This speeds up the deposit process.

In contrast, when a piece of money in the specific (special) shape is included in the money put in the machine, difficulty in the process increases, which increases the possibility that the frequency in which an error occurs increases. In such a case, it suffices that setting be done for transporting money via the holding route.

The type information acquiring unit 78b also determines whether a piece of money put in the deposit unit 41 is an unfit note and is a genuine note, and sends a result of the determination to the condition determining unit 77.

When the determination result received from the type information acquiring unit 78b represents that a piece of money is an unfit note and is a genuine note, the condition determining unit 77 determines that the predetermined condition is satisfied, and selects and sets the non-holding route as the money transporting route. In contrast, when the determination result received from the type information acquiring unit 78b represents that the money includes a paper sheet highly likely to be an unfit note or a counterfeit note, the process sometimes becomes unstable, which can increase the possibility that the frequency in which an error occurs. In this case, to prevent such a problem, it suffices that setting be done to select and set the holding route is selected as the money transporting route. The paper sheet about which the identifying unit 50 determines that it is highly likely to be an unfit note or a counterfeit note is then stored in the reject unit 44.

As described above, in the depositing and dispensing machine according to the embodiment, when the pieces of money put in the machine are unfit notes and are genuine notes, the pieces of put-in money are identified and counted and then stored in the sorted-money storage unit 45 without being temporarily held in the escrow unit 43, which speeds up the deposit process.

The condition determining unit 77 is a processing unit that selects and sets the non-holding route as the money transporting route when it determines that the predetermined condition is satisfied based on the predetermines signals and determination results input from, for example, the operation determining unit 72, the user identifying unit 74, the reliability-level determining unit 75, and the valuable-medium information acquiring unit 78.

The condition determining unit 77 determines whether to switch the money transporting route to the non-holding route based on the signals sent from, for example, the banknote detecting unit 41a and the coin detecting unit 41b of the deposit unit 41, the storage-limit detecting unit 45a provided to the sorted-money storage unit 45, and the environmental state detecting unit 47 provided to the upper unit 15.

Specifically, the condition determining unit 77 determines whether all pieces of money put in the deposit unit 41 are coins based on the signals received from the banknote detecting unit 41a and the coin detecting unit 41b. When the condition determining unit 77 determines that all pieces of the put-in money are coins, it determines that the predetermined condition is satisfied, and selects and sets the non-holding route as the money transporting route. The condition determining unit 77 may be configured to select and set the holding route as the money transporting route when banknotes and coins are mixed in the put-in money, or when the put-in money includes only banknotes. When coins and banknotes are mixed, the non-holding route may be selected for transporting coins and the holding route may be selected for transporting banknotes.

Thus, for example, to a user who requires speeding up of the deposit process rather than strictness during transactions, because money to be deposited is in a relatively small amount, because the put-in money is stored in the sorted-money storage unit 45 without being temporarily held in the escrow unit 43, the deposit process speeds up, which increases the convenience.

The condition determining unit 77 determines whether the limit of the number of pieces of money that can be stored in the sorted money storage unit 45 is equal to or larger than a predetermined number (for example 200) based on the signal received from the storage-limit detecting unit 45a. When the limit is equal to or larger than the predetermined number, the condition determining unit 77 determines that the predetermined condition is satisfied, and sets and selects the non-holding route as the money transporting route. The condition determining unit 77 may be configured to, when the limit is smaller than the predetermined number (near-full state), set and select the holding route as the money transporting route.

Thus, in the depositing and dispensing machine according to the embodiment, when a large number of (for example, more than 200) pieces of money are put in the machine when the sorted-money storage unit 45 is in the near-full state, the money is not directly transported to the sorted-money storage unit 45 but temporarily held in the escrow unit 43. Therefore, even when the sorted-money storage unit 45 is filled with money during the deposit process, the process can be continued to the limit of the number of pieces of money that can be stored in the escrow unit 43. Although it depends on the number of pieces of money, the process can be continued for one more transaction even when the sorted-money storage unit 45 is filled with money, which facilitates the deposit process.

When the humidity near the transporting unit 46 is out of the predetermined range, or the temperature near the transporting unit 46 is out of the predetermined range, the condition determining unit 77 determines that the predetermines condition is satisfied based on the signal received from the environmental state detecting unit 47 provided to the upper unit 15, and selects and sets the non-holding route as the money transporting route. The condition determining unit 77 may be configured to, when the humidity near the transporting unit 46 is within the predetermined range and the temperature near the transporting unit 46 is within the predetermined range, select and set the holding route as the money transporting route.

Thus, with the depositing and dispensing machine according to the embodiment, when it is highly likely that the money-transporting state changes with an excessive increase in temperature or humidity and thus an error such as jamming occurs during the transporting, the money is transported via the non-holding route. Therefore, the money is not temporarily held in the escrow unit 43, and the deposit process can be completed speedily.

The condition determining unit 77 determines whether to switch the money transporting route to the non-holding route, periodically referring to the time table (see FIG. 6) and the operation record table (see FIG. 7) in the memory unit 14 at predetermined timing.

Specifically, the condition determining unit 77 refers to the time table at the predetermined timing (for example, each one hour), and when it is the peak time, the manager is present, or it is the period in which the manned operation is performed, the condition determining unit 77 determines that the predetermined condition is satisfied, and selects and sets the non-holding route as the money transporting route. The condition determining unit 77 may be configured to select and set the holding route as the money transporting route when it is the off-peak time, when it is the period in which the manager is absent, or when it is the period in which the unmanned operation is performed.

Thus, in the peak time, when the manager is present, or when the manned operation is performed, in which speeding up the deposit process is required rather than strictness during transactions, the money put in the depositing and dispensing machine is stored in the sorted-money storage unit 45 without being temporarily held in the escrow unit 43, which speeds up the deposit process.

In contrast, when the manager is absent, or when the unmanned operation is performed, in which strictness during transactions is required rather than speeding up the deposit process, the money put in the depositing and dispensing machine is temporarily held in the escrow unit 43 and then stored in the sorted-money storage unit 45 by an accepting operation by the user, which achieves a strict transaction.

Furthermore, in the depositing and dispensing machine, by doing setting such that money is temporarily held in the escrow unit 43 when the manager is absent or when the unmanned operation is performed, cash about which it is determined that the it is to be processed can be separated from cash about which it is not determined that it is to be processed can be distinguished from each other even when a trouble such as jamming occurs. Therefore, it is less likely that a method of processing cash is erroneously adopted when dealing with the trouble such as jamming.

The condition determining unit 77 refers to the operation record table at predetermine time intervals (for example each one hour), and calculates a ratio of stops resulting from troubles in the transporting unit 46. When the stop rate is equal to or smaller than a pre-set specified value, the condition determining unit 77 determines that the predetermined condition is satisfied, and selects and sets the non-holding route as the money transporting route. The condition determining unit 77 may be configured to, when the stop rate exceeds the specified value, select and set the holding route as the money transporting route.

Thus, in the depositing and dispensing machine according to the embodiment, when a rate in which the trouble such as jamming occurs is relatively low, the money put in the machine is stored in the sorted-money storage unit 45 without being temporarily held in the escrow unit 43, which speeds up the deposit process.

In contrast, when the rate in which the trouble such as jamming occurs is relatively high in the depositing and dispensing machine, by storing the put-in money in the sorted-money storage unit 45 after temporarily holding the put-in money in the escrow unit 43, cash about which it is determined that it is to be processed can be separated from the cash about which it is not determine that is to be processed even when the trouble such as jamming occurs.

As described above, in the depositing and dispensing machine according to the embodiment, setting can be done to switch the money transporting route from the holding route to the non-holding route, or from the non-holding route to the holding route, depending on the situation based on the condition determination by the condition determining unit 77 of the control unit 70 of the terminal 2. Therefore, when speeding up the deposit process is prioritized, the money put in the machine is stored in the sorted-money storage unit 45 without being temporarily held in the escrow unit 43, which speeds up the deposit process.

In contrast, in the depositing and dispensing machine, when strictness during transactions is prioritized rather than speeding up the deposit process, the put-in money can be temporarily held in the escrow unit 43 and then stored in the sorted-money storage unit 45, which leads to strict deposit process.

As shown in FIG. 3, the valuable-medium information acquiring 78 is provided in the control unit 70 of the terminal 2. However, the valuable-medium information acquiring 78 is not necessarily provided to the terminal 2. Alternatively, a configuration may be adopted in which the valuable-medium information acquiring 78 is provided to the processor 1. In this case, when the condition determining unit 77 performs condition determination, valuable-medium information is received from the valuable-medium information acquiring unit 78 provided to the processor 1.

As shown in the depositing and dispensing machine shown in FIG. 3, the configuration is adopted in which only the terminal 2 is provided with the control unit 70 and the control unit 70 generally controls operations of the depositing and dispensing machine. Alternatively, a configuration may be adopted in which the processor 1 is provided with a control unit for the processor 1. In this case, a function of controlling operations of the processor 1 out of the control functions of the control unit 70 is separated and given to the control unit for the processor 1.

The processes performed by the control unit 70 of the depositing and dispensing machine according to the embodiment are explained below with reference to FIGS. 8 to 10. FIGS. 8 to 10 are flowcharts of the processes performed by the control unit 70 of the depositing and dispensing machine. The control unit 70 of the depositing and dispensing machine repeatedly performs the processes represented in the flowcharts shown in FIGS. 8 to 10 while the power is supplied.

As shown in FIG. 8, after the power is supplied to the depositing and dispensing machine, the control unit 70 refers to the time table (see FIG. 6) (step S101) and determines whether “1” is stored as a flag in the time table (step S102).

When “1” is stored as a flag, i.e., when it is the peak time, when the manager is present, or when the manned operation is performed (YES at step S102), the control unit 70 performs a transporting route setting process (1) (step S103). In the transporting route setting process (1), the control unit 70 selects and sets the non-holding route as the money transporting route.

In contrast, when “0” is stored as a flag in the time table, i.e., when it is the off-peak time, when the manager is absent, or when the unmanned operation is performed (NO at step S102), the control unit 70 performs a transporting route setting process (2) (step S104). In the transporting route setting process (2), the control unit 70 selects and sets the holding route as the money transporting route.

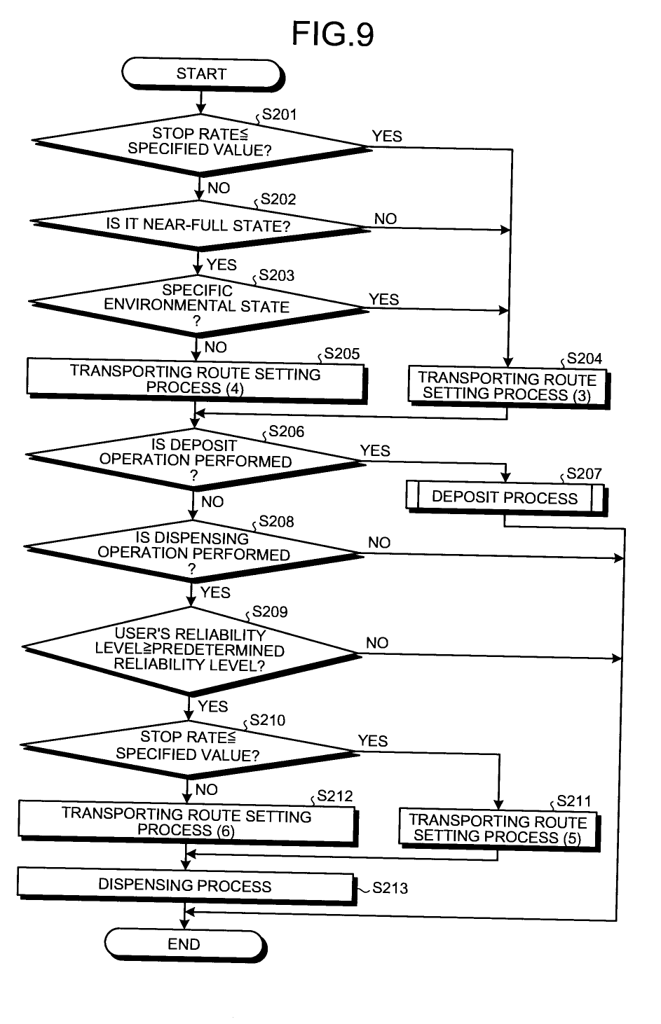

Subsequently, the control unit 70 determines whether there is an interrupting process (step S105). When the control unit 70 determines that there is an interrupting process (YES at step S105), the control unit 70 shifts the process to step S106, and performs the interrupting process. The interrupting process is specifically explained below with reference to FIG. 9. When the control unit 70 determines that there is no interrupting process (NO at step S105), the control unit 70 completes the processing and restarts the process from step S101.

The interrupting process performed by the control unit 70 at step S105 is explained below. The interrupting process is performed when, for example, the control unit 70 refers to the memory unit 14 at a predetermined cycle, the control unit 70 receives the predetermined signals or determination results from the banknote detecting unit 41a, the coin detecting unit 41b, the quantity detecting unit 41c, and the storage-limit detecting unit 45a, the environmental state detecting unit 47, and the identifying unit 50, the user information receiving unit 12 receives an ID card of a user, or when the user operates the display operation unit 11.

As shown in FIG. 9, when the interrupting process is started, the control unit 70 determines whether the stop rate of the transporting unit 46 is equal to or smaller than the specified value based on the operation record table (see FIG. 7) (step S201). When the control unit 70 determines that the stop rate is equal to or smaller than the specified value (YES at step S201), the control unit 70 shifts the process to step S204. In contrast, when the control unit 70 determines that the stop rate exceeds the specified value (NO at step S201), the control unit 70 shifts the processing to step S202.

At step S202, the control unit 70 determines whether the sorted-money storage unit 45 is in the near-full state. When the control unit 70 determines that the sorted-money storage unit 45 is not in the near-full state (NO at step S202), the control unit 70 shifts the process to step S204. In contrast, when the control unit 70 determines that the sorted-money storage unit 45 is in the near-full state (YES at step S202), the control unit 70 shifts the process to step S203.

At step S203, the control unit 70 determines whether it is in a specific environmental state. At step S203, the control unit 70 determines that it is in the specific environmental state when the humidity or temperature near the transporting unit 46 is out of the predetermined range.

When the control unit 70 determines that it is in the specific environmental state (YES at step S203), the control unit 70 shifts the process to step S204. In contrast, when the control unit 70 determines that it is not in the specific environmental state (NO at step S203), the control unit 70 shifts the process to step S205.

At step S203, the control unit 70 selects and sets the non-holding route as the money transporting route by performing a transporting route setting process (3) and then shifts the process to step S206. At step S205, the control unit 70 selects and sets the holding route as the money transporting route by performing a transporting route setting process (4) and then shifts the process to step S206.

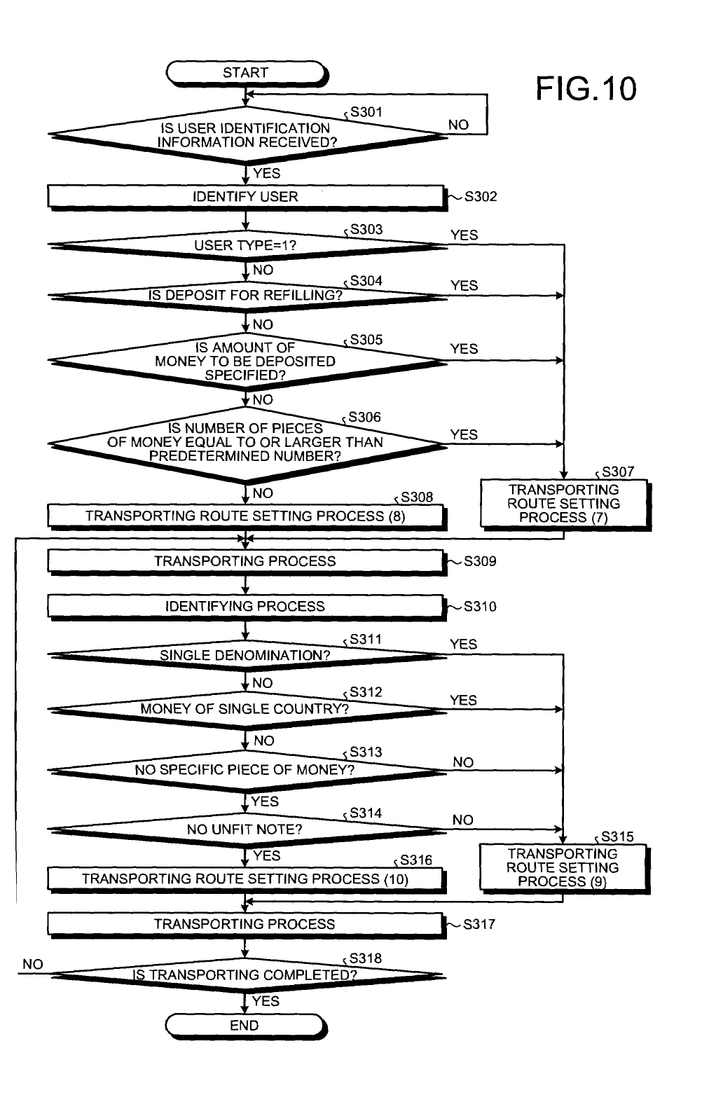

At step S206, the control unit 70 determines whether the user performs the deposit operation. When the control unit 70 determines that the deposit operation is performed (YES at step S206), the control unit 70 performs the deposit process (step S207), and thereafter, completes the process. The deposit process is explained specifically below with reference to FIG. 10.

In contrast, when the control unit 70 determines that the deposit operation is not performed (NO at step S206), the control unit 70 determines whether the dispensing operation is performed by the user (step S208). When the control unit 70 determines that the dispensing operation is performed (YES at step S208), the control unit 70 shifts the process to step S209. In contrast, when the control unit 70 determines that the dispensing operation is not performed (NO at step S208), the control unit 70 completes the process.

At step S209, the control unit 70 determines whether the user has a level of reliability equal to or higher than the predetermined level of reliability. When the control unit 70 determines that the level of reliability of the user is equal to or higher than the predetermined level of reliability (YES at step S209), the control unit 70 shifts the process to step S210. In contrast, when the control unit 70 determines that the level of reliability of the user is lower than the predetermined level of reliability (NO at step S209), the control unit 70 completes the process.

At step S210, the control unit 70 determines whether the stop rate of the transporting unit 46 is equal to or smaller than the predetermined specified value. When the control unit 70 determines that the stop rate is equal to or lower than the predetermined specified value (YES at step S210), the control unit 70 shifts the processing to step S211. In contrast, when determines that the stop rate of the transporting unit 46 exceeds the predetermined specified value (NO at step S210), the control unit 70 shifts the process to step S212.

At step S211, the control unit 70 selects and sets the non-holding route as the money transporting route by performing a transporting route setting process (5) and then shifts the process to step S213. At step S212, the control unit 70 selects and sets the holding route as the money transporting route, and then, shifts the process to step S213. The control unit 70 performs the dispensing process at step S213 and then completes the process.

In the flowchart shown in FIG. 9, explanation is provided taking, as an example, the case where the non-holding route is selected and set as the money transporting route when the stop rate of the transporting unit 46 is equal to or lower than the specified value, when the sorted-money storage unit 45 is not in the near-full state, or when the environmental state near the transporting unit 46 is in the specific environmental state. However, the procedure of the process performed by the control unit 70 is not limited to this. Alternatively, the money transporting route may be selected and determined from the holding route and the non-holding route depending on the state according to other process procedures, and the determined route may be set.

For example, when the stop rate of the transporting unit 46 is equal to or lower than the specified value, the sorted-money storage unit 45 is not in the near-full state, and the environmental state near the transporting unit 46 is in the specific environmental state, the process to be performed by the control unit may be changed to a process for selecting the non-holding route as the money transporting route.

In the flowchart shown in FIG. 9, explanation is provided taking, as an example, the case where, when the stop rate of the transporting unit 46 is higher than the specified value, the sorted-money storage unit 45 is in the near-full state, and the environmental state near the transporting unit 46 is not in the specific environmental state, the holding route is selected and set as the money transporting route. Alternatively, the process to be performed by the control unit 70 may be changed to a process for selecting the non-holding route as the money transporting route when the stop rate of the transporting unit 46 is higher than the specified value, the sorted-money storage unit 45 is in the near-full state, or the environmental state near the transporting unit 46 is not in the specific environmental state.

The deposit process performed by the control unit 70 at step S208 is explained with reference to FIG. 10. As shown in FIG. 10, after the deposit process is started, the control unit 70 determines whether the user information receiving unit 12 receives user identification information (step S301).

When the control unit 70 determines that user information is not received (NO at step S301), the control unit 70 repeats the determination process at step S301 until user information is received. In contrast, when the control unit 70 determines that user identification information is received (YES at step S301), the control unit 70 refers to the user information table (see FIG. 5) and identifies the user (step S302). Thereafter, the control unit 70 determines whether the user type determined at step S302 is “1” representing the specific user (step S303).

When the control unit 70 determines that the user type determined at step S302 is “1” (YES at step S303), the control unit 70 shifts the process to step S307. In contrast, when the control unit 70 determines that the user type is not “1” (NO at step S303), the control unit 70 shifts the process to step S304.

At step S304, the control unit 70 determines whether the type of the deposit operation by the user is deposit for refilling. When the control unit 70 determines that the type of the deposit operation is deposit for refilling (YES at step S304), the control unit 70 shifts the process to step S307. In contrast, when the control unit 70 determines that the type of the deposit operation is not deposit for refilling (NO at step S304), the control unit 70 shifts the process to step S305.

At step S305, the control unit 70 determines whether the amount of money to be deposited is specified. When the control unit 70 determines that the amount of money to be deposited is specified (YES at step S305), the control unit 70 shifts the process to step S307. In contrast, when the control unit 70 determines that the amount of money to be deposited is not specified (NO at step S305), the control unit 70 shifts the process to step S306.

At step S306, the control unit 70 determines whether the number of pieces of money put in the deposit unit 41 is equal to or larger than the predetermined number. When the control unit 70 determines that the number is equal to or larger than the predetermined number (YES at step S306), the control unit 70 shifts the process to step S307. In contrast, when the control unit 70 determines that the number of pieces of money put in the deposit unit 41 is smaller than the predetermined number (NO at step S306), the control unit 70 shifts the process to step S308.

At step S307, the control unit 70 selects and sets the non-holding route as the money transporting route by performing a transporting route setting process (7). Thereafter, the control unit 70 shifts the process to step S309. At step S308, the control unit 70 selects and sets the holding route as the money transporting route by performing a route setting process (8). Thereafter, the control unit 70 shifts the process to step S309.

At step S309, the control unit 70 controls the transporting unit 46 to perform the transporting process for transporting the money put in the deposit unit 41 to the identifying unit 50. Thereafter, based on the valuable-medium information received from the valuable-medium information acquiring unit 78, the control unit 70 performs the identifying process on the put-in money (step S310).

Subsequently, based on the result of the identifying process, the control unit 70 determines whether the pieces of money put in the deposit unit 41 are of a single money type (step S311). When the control unit 70 determines that the pieces of money are of a single money types (YES at step S311), the control unit 70 shifts the process to step S315. In contrast, when the control unit 70 determines that the pieces of money are not of a single money types (NO at step S311), the control unit 70 shifts the process to step S312.

At step S312, the control unit 70 determines whether the pieces of money put in the deposit unit 41 are money of a single country. When the control unit 70 determines that the pieces of money are money of a single country (YES at step S312), the control unit 70 shifts the process to step S315. In contrast, when the control unit 70 determines that the pieces of money are not money of a single country (NO at step S312), the control unit 70 shifts the process to step S313.

At step S313, it is determined whether the money put in the deposit unit 41 includes a specific piece of money (for example, a polygonal coin). When it is determined that the money put in the deposit unit 41 does not include the specific pieces of money (NO at step S313), the process is shifted to step S315. In contrast, when the control unit 70 determines that that the money put in the deposit unit 41 includes the specific piece of money (YES at step S313), the control unit 70 shifts the process to step S314.

At step S314, it is determined whether the money put in the deposit unit 41 includes an unfit note (including a counterfeit note or a paper sheet that is highly likely to be a counterfeit note). When it is determined that the money does not include an unfit note (NO at step S314), the process is shifted to step S315. In contrast, when the control unit 70 determines that the money includes an unfit note (YES at step S314), the control unit 70 shifts the process to step S316.

At step S315, the control unit 70 selects and sets the non-holding route as the money transporting route by performing a transporting route setting process (9) and then shifts the process to step S317. At step S316, the control unit 70 selects and sets the holding route as the money transporting route by performing a transporting route setting process (10) and then shifts the process to step S317.

At step S317, the control unit 70 controls the transporting unit 46 to perform the transporting process for sending out the money from the identifying unit 50. When the control unit 70 switches the money transporting route to the holding route, the money is transported from the identifying unit 50 to the escrow unit 43. When the control unit 70 switches the money transporting route to the non-holding route, the money is transported from the identifying unit 50 to the sorted-money storage unit 45.

Thereafter, the control unit 70 determines whether the transporting process for sending out all pieces of money input in the deposit unit 41 are sent from the identifying unit 50 is completed (step S318). When the control unit 70 determines that the transporting process is completed (YES at step S318), the control unit 70 completes the process. When the control unit 70 determines that the transporting process is not completed (NO at step S318), the control unit 70 shifts the process to step S309.

As described above, in the depositing and dispensing machine according to the embodiment, the condition determining unit 77 provided to the control unit 70 does setting to switch the money transporting route from the holding route to the non-holding route or from the non-holding route to the holding route depending on the situation. Therefore, in the situation where speeding up the deposit process is prioritized, money put in the machine can be stored in the sorted-money storage unit 45 without being temporarily stored in the escrow unit 43, which speeds up the deposit process.

In contrast, in the situation in which strictness during transactions is prioritized rather than speeding up the deposit process in the depositing and dispensing machine based on the condition determination by the condition determining unit 77, the put-in money is temporarily held in the escrow unit 43 and then stored in the sorted-money storage unit 45, which leads to a strict deposit process.

In the flowchart shown in FIG. 10, explanation is provided taking, as an example, the case where the non-holding route is selected and set as the money transporting route when the user type is “1”, when deposit is for refilling, when the amount of money to be deposited is specified, or when the number of pieces of money to be deposited is equal to or larger than the predetermined number. Alternatively, the process to be performed by the control unit 70 may be changed to a process for selecting and setting the non-holding route as the money transporting route when the user type is “1”, when the deposit is for refilling, when the amount of money to be deposited is specified, and when the number of pieces of money to be deposited is equal to or larger than the predetermined number.

In the flowchart shown in FIG. 10, explanation is provided taking, as an example, the case where the holding route is selected and set as the money transporting route when the user type is not “1”, when deposit is not for refilling, when the amount of money to be deposited is not specified, and when the number of pieces of money to be deposited is smaller than the predetermined number. Alternatively, the process to be performed by the control unit 70 may be changed to a process for selecting and setting the holding route as the money transporting route when the user type is not “1”, when the deposit is not for refilling, when the amount of money to be deposited is not specified, or when the number of pieces of money to be deposited is smaller than the predetermined number.

Furthermore, in the flowchart shown in FIG. 10, explanation is provided taking, as an example, the case where the non-holding route is selected and set as the money transporting route when the pieces of money put in the processor 1 are of a single type, are money of a single country, do not include the specific piece of money, or do not include an unfit note. Alternatively, the process to be performed by the control unit 70 may be changed to a process for selecting and setting the non-holding route as the money transporting route when the pieces of money put in the processor 1 are of a single type, are money of a single country, do not include the specific piece of money, and do not include an unfit note.

In the flowchart shown in FIG. 10, explanation is provided taking, as an example, the case where the holding route is selected and set as the money transporting route when the pieces of money put in the processor 1 are not of a single money type, are not money of a single country, include the specific piece of money, and include an unfit note. Alternatively, the process performed by the control unit may be changed to a process for selecting and setting the holding route as the money transporting route when the pieces of money put in the processor 1 are not of a single money type, are not money of a single country, include the specific piece of money, or include an unfit note.

The references listed in the embodiment with which the condition determining unit 77 determines whether the predetermined condition is satisfied are just examples. Alternatively, the dispensing and depositing machine may be configured such that the dispensing and depositing machine sets other determination references using the various types of information acquired when identifying pieces of money. In this case, the condition determining unit 77 is caused to determine whether the predetermined condition is satisfied based on the determination references, and the money transporting route is selected and switched.

For example, the depositing and dispensing machine may be configured such that the valuable-medium information acquiring unit 78 is provided with a front-back information acquiring unit that acquires front-back information representing the front or back of a valuable medium put in the receptacle. In this case, based on the front-back information acquired by the front-back information acquiring unit, the control unit 70 controls the transporting unit 46 to select and set the money transporting route from the holding route and the non-holding route, and the money is transported in the determined route.

Alternatively, the depositing and dispensing machine may be configured such that the storage-limit detecting unit 45a is caused to function as a storage state detecting unit that detects whether there is money in the storage unit. In this case, when the storage state detecting unit detects that there is no money in the storage unit, the control unit 70 determines that the predetermined condition is satisfied, and selects the non-holding route as the money transporting route when transporting the money to a storage unit about which it is detected that no money is stored in the storage unit.

With this configuration, because only when no money is stored in the storage unit that stores therein money, money is stored in the storage unit, a time necessary to store money is shortened compared with the case where money is stored via the escrow unit.

Even when money is erroneously deposited in one deposit, because the storage unit in which money is to be stored is limited to an empty storage unit, the deposited money is not mixed with money already stored, and only the deposited money can be taken out.

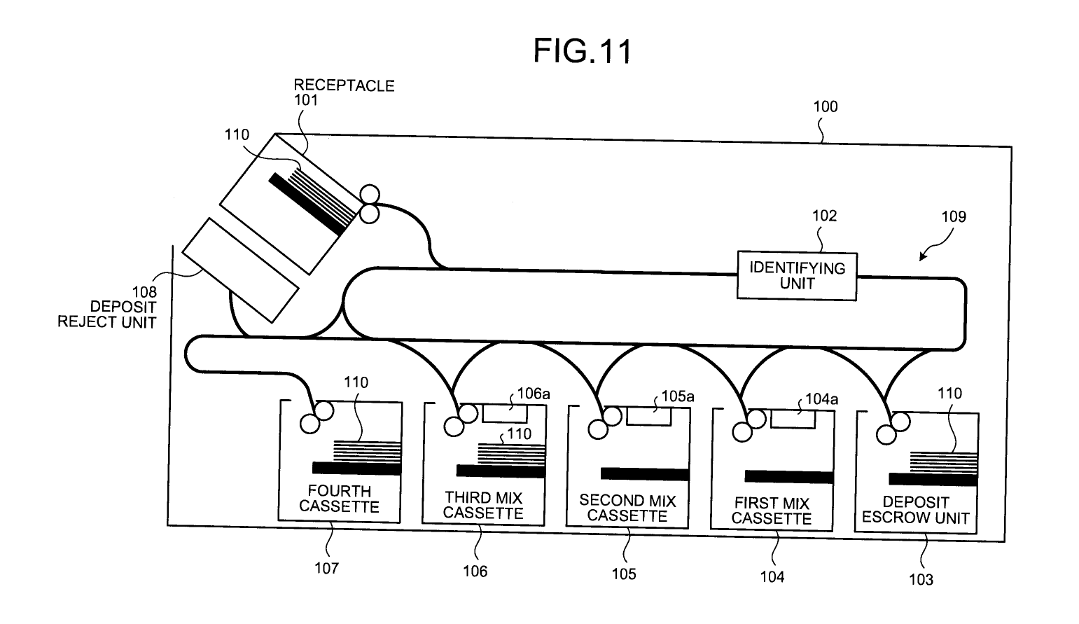

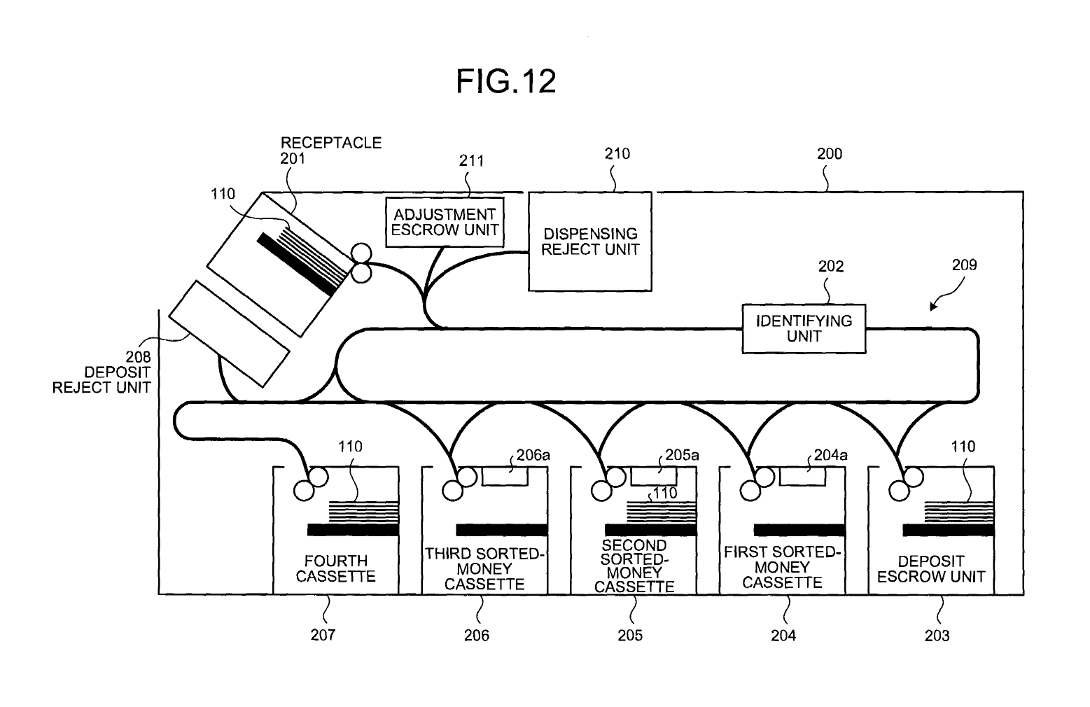

Other examples are explained with reference to FIGS. 11 and 12. First, with reference to FIG. 11, is explained as an example a processor configured such that the control unit 70 determines that the predetermined condition is satisfied when a storage state detecting unit detects that there is no money in a storage unit, and selects the non-holding route as the money transporting route when transporting the money to the storage unit about which it is detected that there is no money in the storage unit.

As shown in FIG. 11, a processor 100 includes a receptacle 101, an identifying unit 102, a deposit escrow unit 103, a first mix cassette 104, a second mix cassette 105, a third mix cassette 106, a fourth collective cassette 107, a deposit reject unit 108, and a transporting unit 109.

The receptacle 101 is provided on the front surface of the processor 100, and it has a function in which, after a user, specifically, a bank clerk sets a plurality of banknotes 110 as they are stacked and operates a predetermined deposit button (not shown), the banknotes 110 are paid out one by one and taken into the processor 100.

The identifying unit 102 is provided on a transporting route of the transporting unit 109, and it has a function of identifying the banknotes 110 transported from the receptacle by determining the money type (one-thousand yen note, two-thousand yen note, five-thousand yen note, and ten-thousand yen note), whether they are fit or unfit, or whether they are genuine or counterfeit.

The deposit escrow unit 103 is provided to a lower portion of the processor 1. The deposit escrow unit is a cassette that temporarily stores therein the banknotes 110 deposited from the receptacle 101. On the top end of the deposit escrow unit 103, is provided a three-way branch valve for switching a transporting direction such that the banknotes 110 to be transported via the transporting route are transported to the deposit escrow unit 103. The banknotes 110 that are not discharged to the deposit reject unit 108 among the banknotes 110 that are deposited are temporarily stored in the deposit escrow unit 103.

The banknotes 110 stored in the deposit escrow unit 103 are paid out from the deposit escrow unit 103 by the user operating a switch for returning or storing the banknotes 110 (not shown). When returning the banknote 110, the banknotes 110 paid out from the deposit escrow unit 103 are stored in the first to third mix cassettes 104 to 106 via the identifying unit 102.

The first to third mix cassettes 104 to 106 are provided in parallel in a lower portion of the processor 110, and the banknotes 110 are stored therein in a state where money types are mixed. A tree-way branch valve is provided on an upper end of each of the first to third mix cassettes 104 to 106. Depending on the direction of the valve, storing the banknotes 110 in the first to third mix cassettes 104 to 106 and causing the banknotes 110 to pass therethrough are switched in between.

When the user issues an instruction for storing the banknotes 110, the banknotes 110 held in the deposit escrow unit 103 are transported from the deposit escrow unit 103 to the first to third mix cassettes 104 to 106. The banknotes 110 to be transported are transported from the deposit escrow unit 103 via the identifying unit 102 from the left side of FIG. 11, and stored in the first to third mix cassettes 104 to 106.

Storage state detecting units 104a, 105a, and 106a that detect whether there is a banknote in a cassette are provided respectively in the first to third mix cassettes 104 to 106.

The fourth collective cassette 107 is a cassette provided in parallel with the deposit escrow unit 103 and the first to third mix cassettes 104 to 106.

The banknotes 110 about which an instruction is issued to store the banknotes 110 in the deposit escrow unit 103 pass through the identifying unit 102. However, when the identifying unit 102 cannot identify the banknotes 110 or when it is determined that the banknotes 110 are unfit notes, they are stored in the fourth collective cassette 107.

The banknotes 110 about which the identifying unit 102 determines that they cannot be identified, or the banknotes 110, about which it is determined that they are unfit notes, are discharged to the deposit reject unit 108 via the lower side of the transporting route formed on in loop.

Operations of the processor 100 shown in FIG. 11 for performing the deposit process are explained below. In the processor 100 shown in FIG. 11, after the user sets the banknotes 110 in the receptacle 101, it is determined whether there is an empty cassette in which the banknote 110 is not stored among the first to third mix cassettes 104 to 106 based on detection results of the respective storage state detecting units 104a, 105a, and 106a.

For example, when the second mix cassette 105 and the first mix cassette 104 are empty in the processor 100 as shown in FIG. 11, it is automatically determined to transport the banknotes 110 in a route (non-holding route) not using the deposit escrow unit 103, and the banknotes 110 set in the receptacle 101 are directly deposited in the first mix cassette 104 via the identifying unit 102. On the next deposit, the banknotes 110 are deposited in the second mix cassette 105 that is the next empty cassette also via the non-holding route.

On the further next deposit in the processor 100, because there is already no empty cassette, the banknotes 110 set in the receptacle 101 by the user are paid out one by one. After the money types of the banknotes 110 are determined and the banknotes 110 are counted by the identifying unit 102, they are deposited in the deposit escrow unit 103.

Thereafter, when the deposit is completed, the processor 100 issues an instruction to a user to determine whether to authorize the deposit. When an accepting switch (not shown) is operated, the banknotes 110 are transported to the first to third mix cassettes 104 to 106 from the deposit escrow unit 103, and stored therein.

In other words, when banknotes are set in the receptacle 101 in the processor 100 and there is no empty cassette, the banknotes 110 are held in the deposit escrow unit 103 and then transported in the route (holding route) for depositing the banknotes 110 in the first to third mix cassettes 104 to 106, and stored therein.

In this case, when the cassettes are sequentially filled with the banknotes 110 from the third mix cassette 106 on the side of the fourth collective cassette 107, the cassette in which the banknotes 110 are to be stored is switched to the next cassette, and the banknotes 110 are sequentially stored in the cassette. In this example, when the banknotes 110 are set in the receptacle 101, the deposit route is automatically selected. Alternatively, a configuration may be adopted in which, when the banknotes 110 are set, the user switches the deposit route by selecting a selects a storing method.

Alternatively, the depositing and dispensing machine may be configured such that, when the above-described storage state detecting units 104a, 105a, and 106a detect that there is no money in the sorted-money storage units 45 corresponding to information representing the money type acquired by the valuable-medium information acquiring unit 78, the control unit 70 determines that the predetermined condition is satisfied, and selects the non-holding route as the money transporting route.

With this configuration, the sorted-money storage units 45 are divided based on money types such as money types of banknotes. Therefore, when various types of money are deposited, only money to be stored in the sorted-money storage unit 45 in which no money is stored is stored not via the escrow unit 43. Thus, the time required for storing money is shortened compared with the case where money is stored via the escrow unit.

Subsequently, with reference to FIG. 12, is explained an example of a processor configured such that a storage state detecting unit detects that there is no money in a sorted-money storage unit corresponding to information representing the money type acquired by the valuable-medium information acquiring unit 78, the control unit 70 determines that the predetermined condition is satisfied, and selects and sets the non-holding route as the money transporting route.

As shown in FIG. 12, a processor 200 includes a receptacle 201, an identifying unit 202, a deposit escrow unit 203, a first sorted-money cassette 204, a second sorted-money cassette 205, a third sorted-money cassette 206, a fourth collective cassette (4) 207, a deposit reject unit 208, a transporting unit 209, a dispensing reject unit 210, and an adjustment escrow unit 211.

In the processor 200, the identifying unit 202, the deposit escrow unit 203, the fourth collective cassette 207, the deposit reject unit 208, the transporting unit 209 have the same functions as those of the identifying unit 102, the deposit escrow unit 103, the fourth collective cassette 107, the deposit reject unit 108, and the transporting unit 109 of the processor 100.

The receptacle 201 is used not only to set the banknotes 110 to be deposited but also to stack the banknotes 110 to be dispensed. For this reason, the receptacle 201 is provided with a shutter (not shown), and when stacking the banknotes 110 to be dispensed is completed, the shutter is opened such that the banknotes to be dispensed can be taken out.

The dispensing reject unit 210 is provided on the side on which the user performs operations. The dispensing reject unit 210 is a receptacle to which the banknote 110 that cannot be identified by the identifying unit 202 because, for example, it was obliquely transported when dispensed is discharged.

The adjustment escrow unit 211 is an adjustment escrow unit. When the user issues an instruction for binding is issued, the banknotes 110 are paid out from the first to third sorted-money cassettes 204 to 206, which are to be described below, and are stacked to a predetermined number (100) in the adjustment escrow unit 211. The stacked banknotes 110 stacked in the adjustment escrow unit 211 are bound by a binding unit (not shown).

The first to third sorted-money cassettes 204 to 206 are provided such that the banknotes 110 are stored on a money type basis. In this example, the first sorted-money cassette 204 is allocated ten-thousand yen notes, the second sorted-money cassette 205 is allocated five-thousand yen notes, and the third sorted-money cassette 206 is allocated one-thousand yen notes. The banknotes are sorted according to the money types when stored, and stored in the cassettes.

Storage state detecting units 204a, 205a, and 206a that detect whether there is a banknote in each cassette are provided respectively in the first to third sorted-money cassettes 204 to 206.

Operations of the processor 200 shown in FIG. 12 for performing the deposit process are explained below. In the processor 200 shown in FIG. 12, after the user sets banknotes in the receptacle 201, it is determines whether there is an empty cassette in which the banknote 110 is not stored among the first to third sorted-money cassettes 204 to 206 based on detection results of the respective storage state detecting units 204a, 205a, and 206a.

For example, when the first sorted-money cassette 204 and the third sorted-money cassette 206 are empty in the processor 200 as shown in FIG. 12, it is automatically determined to transport ten-thousand yen notes and one-thousand yen notes in a route (non-holding route) not using the deposit escrow unit 203, and store the banknotes. One-thousand yen notes of the banknotes 110 set in the receptacle 201 are deposited in the third sorted-money cassette 206 via the identifying unit 202, and ten-thousand yen notes are deposited in the first sorted-money cassette 204 via the identifying unit 202.

In contrast, when the banknotes 110 set in the receptacle 201 are five-thousand yen notes in the processor 200, because banknotes are stored in the second sorted-money cassette 205 that stores therein five-thousand yen notes, the banknotes 110 are not transported to the second sorted-money cassette 205 but stored temporarily in the deposit escrow unit 203.

When the banknotes 110 set in the receptacle 201 are two-thousand yen notes, the banknotes 110 are temporarily stored in the deposit escrow unit 203 because there is no cassette allocated two-thousand yen notes in the processor 200.

In other words, in this case, while one-thousand yen notes and ten-thousand yen notes are transported via the non-holding route in the processor 200, five-thousand yen notes and two-thousand yen notes are transported via the holding route.

When the deposit is competed in the processor 200, an instruction to determine whether to authorize the deposit is issued to the user. When an authorizing switch (not shown) is operated, five-thousand yen notes are transported from the deposit escrow unit 203 to the second sorted-money cassette 205 and stored therein, and two-thousand yen notes are transported to the fourth collective cassette 207 and stored therein.

In this example, when the banknotes 110 are set in the receptacle 201, the deposit route is automatically selected. Alternatively, a configuration may be adopted in which, when the banknotes 110 are set, the route is changed by the user selecting a storing method.

When the deposit route is automatically selected, it is preferable that such an operation is adopted when money is previously refilled prior to the business hours. When refilling money, the money type and the state of money (unfit notes) are roughly known. Therefore, by adopting such an operation only in refilling, errors are less likely to occur, which speeds up the storing.

As described, when various types of money is deposited in the processor 200, only banknotes of a money type that an empty cassette is allocated are transported to the cassette via the non-holding route and stored therein. This shortens the time required for storing banknotes compared with the case where the banknotes are temporarily stored in the deposit escrow unit 203. In addition, because only banknotes to be stored in an empty cassette are directly stored in the cassette, the banknotes are not mixed with the banknotes 110 previously stored even if a trouble occurs, which prevents a trouble.

Operations of the processor 200 for performing the dispensing process are explained below. When the user specifies the amount of money to be dispensed with the processor 200, how many pieces of money are necessary is calculated on a money type basis, and desired numbers of banknotes 100 are dispensed respectively from the first to third sorted-money cassettes 204 to 206.

The banknotes 110 paid out from the first to third sorted-money cassettes 204 to 206 are dispensed to the receptacle 201 via the identifying unit 202. When the identifying unit 202 detects that the banknotes 110 are obliquely transported or transported while being lapped over, the banknotes 110 are discharged to the dispensing reject unit 210.

When binding the predetermined banknotes 110 and dispensing them in the processor 200, 100 banknotes are paid out from each of the first to third sorted-money cassettes 204 to 206 storing therein money types the cassettes (1) to (3) are allocated, and stacked in the adjustment escrow unit 211 one by one. After 100 banknotes are stacked, they are transported to the binding unit (not shown) and bound.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A valuable-medium processing apparatus comprising:
a receptacle in which at least one valuable medium is put;
an escrow unit that temporarily holds the at least one valuable medium;
a storage unit that stores therein valuable mediums;
a transporting unit that includes
a holding route in which the valuable medium put in the receptacle is temporarily held in the escrow unit and then transported to the storage unit, and
a non-holding route in which the valuable medium put in the receptacle is transported to the storage unit without being held in the escrow unit; and
a control unit that, when a predetermined condition is satisfied, controls the transporting unit to determine a transporting route by selecting one of the holding route and the non-holding route, and transport the valuable medium via the determined route.

2. The valuable-medium processing apparatus according to claim 1, further comprising
a valuable-medium information acquiring unit that acquires valuable-medium information about the valuable medium put in the receptacle, wherein
when the control unit determines that the predetermined condition is satisfied based on the valuable-medium information acquired by the valuable-medium information acquiring unit, the control unit controls the transporting unit so that the valuable medium is transported via the non-holding route.

3. The valuable-medium processing apparatus according to claim 2, wherein
the valuable-medium information acquiring unit acquires, as the valuable-medium information, information about a quantity of the valuable medium(s) put in the receptacle, and
the control unit determines that the predetermined condition is satisfied, when the quantity of the valuable medium(s) put in the receptacle is equal to or larger than a predetermined threshold value, based on the information about the quantity of the valuable medium(s) which is acquired by the valuable-medium information acquiring unit.

4. The valuable-medium processing apparatus according to claim 2, wherein
the valuable-medium information acquiring unit includes a type information acquiring unit that acquires, as the valuable-medium information, type information representing a type of the valuable medium put in the receptacle, and
the control unit determines that the predetermined condition is satisfied when the type information acquired by the type information acquiring unit represents a single type.

5. The valuable-medium processing apparatus according to claim 2, wherein
the valuable-medium information acquiring unit acquires information representing a shape or a size of the valuable medium as the valuable-medium information, and
the control unit determines that the predetermined condition is satisfied when the acquired information representing the shape or size of the valuable medium does not contain information representing a valuable medium of a specific shape or specific size.

6. The valuable-medium processing apparatus according to claim 1, further comprising
a storage-limit detecting unit that detects a number of valuable mediums that can be stored in the storage unit, wherein
the control unit determines that the predetermined condition is satisfied when the number of valuable mediums that can be stored, which is detected by the storage-limit detecting unit, is equal to or larger than a predetermined number.

7. The valuable-medium processing apparatus according to claim 1, further comprising
a user identifying unit that identifies a user who puts the valuable medium in the receptacle, wherein
the control unit determines that the predetermined condition is satisfied when the user who is identified by the user identifying unit is a specific user.

8. The valuable-medium processing apparatus according to claim 1, further comprising
a valuable-medium information acquiring unit that acquires, as valuable-medium information about the valuable medium put in the receptacle information about a quantity of the valuable medium(s) put in the receptacle;
a quantity input unit that inputs a quantity of valuable medium(s) to be put in the receptacle;
a discrepancy calculating unit that calculates a discrepancy between the quantity input by the quantity input unit and the quantity of the valuable medium(s) which is acquired by the valuable-medium information acquiring unit;
a discrepancy record memory unit that stores therein the discrepancy detected by the discrepancy calculating unit in association with a user who puts in the valuable medium about which the discrepancy is caused; and
a reliability-level determining unit that determines a level of reliability of the user identified by the user identifying unit based on the information stored in the discrepancy record memory unit, wherein
the control unit determines that the predetermined condition is satisfied, when the level of reliability of the user which is determined by the reliability-level determining unit is equal to or higher than a predetermined level of reliability.

9. The valuable-medium processing apparatus according to claim 1, further comprising
a valuable-medium information acquiring unit that acquires, as valuable-medium information about the valuable medium put in the receptacle, information about an amount of the valuable mediums put in the receptacle;
a user identifying unit that identifies a user who puts the valuable medium in the receptacle;
an input unit that inputs information about any one of type(s), a total amount, a total value of the valuable medium(s) put in the receptacle;
a discrepancy calculating unit that calculates a discrepancy between the information input by the input unit and the information about the valuable medium(s) which is acquired by the valuable-medium information acquiring unit;
a discrepancy record memory unit that stores therein the discrepancy calculated by the discrepancy calculating unit in association with a user who puts in the valuable medium about which the discrepancy is caused; and
a reliability-level determining unit that determines a level of reliability of the user identified by the user identifying unit, wherein
the control unit determines that the predetermined condition is satisfied, when the level of reliability of the user which is determined by the reliability determining unit is equal to or higher than a predetermined level of reliability.

10. The valuable-medium processing apparatus according to claim 1, further comprising
a time table in which timing for selecting and determining a route for transporting the valuable medium is set, wherein
the control unit determines that the predetermined condition is satisfied during a predetermined time set in the time table.

11. The valuable-medium processing apparatus according to claim 2, further comprising
a front-back information acquiring unit that acquires, as the valuable-medium information, front-back information representing front or back of the valuable medium put in the receptacle, wherein
the control unit controls the transporting unit to determine the transporting route by selecting one of the holding route and the non-holding, and transport the valuable mediums via the determined route, based on the front-back information acquired by the front-back information acquiring unit.

12. The valuable-medium processing apparatus according to claim 2, further comprising
a storage state detecting unit that detects whether there is a valuable medium in the storage unit, wherein
the control unit determines that the predetermined condition is satisfied when the storage state detecting unit detects that there is no valuable medium in the storage unit.

13. The valuable-medium processing apparatus according to claim 12, wherein
the storage unit includes a plurality of storage units provided corresponding respectively to the types of valuable mediums, wherein
the control unit determines that the predetermined condition is satisfied,
when the storage state detecting unit detects that there is no valuable medium in at least one of the storage units,
when the valuable-medium information acquiring unit acquires information representing type(s) of the valuable mediums put in the receptacle, and
when the type of the valuable mediums corresponding to the storage unit in which the storage state detecting unit detects that there is no valuable medium is same as the type of the valuable mediums which is acquired by the valuable-medium information acquiring unit.

14. The valuable-medium processing apparatus according to claim 1, further comprising
a valuable-medium information acquiring unit that acquires information about the valuable medium put in the receptacle, wherein
the control unit determines whether the predetermined condition is satisfied, based on the valuable-medium information acquired by the valuable-medium information acquiring unit, and
when the control unit determines that the predetermined condition is satisfied based on the valuable-medium information acquired by the valuable-medium information acquiring unit, the control unit controls the transporting unit to transport the valuable medium via the holding route.

15. A valuable-medium processing method that is performed by a valuable-medium processing apparatus, the valuable-medium processing method comprising:
acquiring valuable-medium information about a valuable medium put in a receptacle;
determining whether a predetermined condition is satisfied based on the acquired valuable-medium information; and
controlling a transporting unit that transports the valuable medium put in the receptacle to a storage unit to determine a transporting route by selecting one of a holding route in which the valuable medium put in the receptacle are temporarily held in an escrow unit and then stored in the storage unit, and a non-holding route in which the valuable medium put in the receptacle are transported to the storage unit without being held in the escrow unit, and transport the valuable medium via the determined route, when the predetermined condition is satisfied.
